(19) United States
(12) Patent Application Publication
(10) Pub. No.: US 2019/0220836 A1
(43) Pub. Date: Jul. 18, 2019

(54) Methods and Systems for Media Distribution Employing Contracts Implemented in a Distributed Ledger

(71) Applicant: Robot Cache, Inc., San Diego, CA (US)

(72) Inventor: Mark Phillip Caldwell, San Diego, CA (US)

(73) Assignee: Robot Cache, Inc., San Diego, CA (US)

(21) Appl. No.: 16/200,155

(22) Filed: Nov. 26, 2018

Related U.S. Application Data
(60) Provisional application No. 62/617,257, filed on Jan. 14, 2018.
(60) Provisional application No. 62/698,562, filed on Jul. 16, 2018.

(51) Int. Cl. G06Q 20/12; G06Q 20/38; G06Q 20/36

(52) U.S. Cl. CPC G06Q 20/123; G06Q 20/389; G06Q 2220/00; G06Q 20/36; G06Q 20/3829; G06Q 20/3825

(57) ABSTRACT

Computer-implemented methods and systems are provided that distribute media content using a distributed ledger maintained by a plurality of nodes. Specifically, first data is stored in the distributed ledger. The first data represents a purchase contract that transfers a digital token associated with a particular digital media content item to a first user in return for payment by the first user. Second data is also stored in the distributed ledger. The second data represents a resale contract that transfers the digital token associated with the particular digital media content item as stored in the first data from the first user to a second user in return for payment by the second user. The digital token associated with the particular digital media content item as part of the first data can be used to grant only the first user permission to access the particular digital media content item unless such digital token is transferred from the first user to another user by data representing a resale contract that is stored in the digital ledger. The digital token associated with the particular digital media content item as part of the second data can be used to grant only the second user permission to access the particular digital media content item unless such digital token is transferred from the second user to another user by data representing a resale contract that is stored in the digital ledger.

### CROSS-REFERENCE TO RELATED APPLICATIONS

The present disclosure claims priority from U.S. Provisional App. No. 62/617,257, entitled “Robot Cache,” filed on Jan. 14, 2018, and U.S. Provisional App. No. 62/698,562, entitled “Methods and Systems for Media Distribution Employing Contracts Implemented in a Distributed Ledger,” filed on Jul. 16, 2018, which are hereby incorporated by reference herein in their entireties.

### BACKGROUND

### 1. Field

The present disclosure relates to the field of decentralized systems. More specifically, embodiments of the disclosure relate to systems and methods for distributing digital media content items (such as online video games) using a distributed electronic ledger, for example, a blockchain.

### 2. State of the Art

Online video games are big business. According to the Entertainment Software Association, 65% of all U.S. households have at least one person who plays 3 or more hours of video games per week. Worldwide, there are approximately 2.2 billion gamers who are expected to generate PC video game revenue of $27.1 billion in 2017. By 2020, PC video game revenue is expected to increase by 9.9% and reach $30 billion annually. The year-on-year growth forecast in video game sales for all major regions of the world continues to trend upwards, with regions like Latin America forecasted to grow 14%.

In 2010, physical video game sales dominated the market, representing 69% of total game purchases. In just 7 short years later, digital game sales have taken over, with 74% of all game purchases being made through various digital formats. According to Nielsen's Law, global Internet connectivity speeds increase by 50% per year, which is a trend that will accelerate the advantage of digital game purchases over retail game purchases, while retail stores fight to keep up. As the world becomes more connected at a breakneck pace, it is anticipated that gamers may purchase an increasing number of digital PC video games.

There are currently over 25 digital PC video game distribution platforms around the globe which sell an increasingly large share of PC video games to consumers of all types. One of the largest is the Steam platform, which was launched in September 2003, and has approximately 14,000 PC video games offered for sale. Steam is estimated to have generated around $3.5 billion of revenue in 2016. There are many other smaller distribution platforms that have the same basic business model.

All of these distribution platforms suffer from several common key drawbacks, such as:

Gamers have no ability to resell their digital PC video games like console gamers can with their physical video games through the physical video game retailers.

Their fees are extraordinarily high, averaging 30% (and even up to 45%) of the sales price.

They don't offer incentive programs that allow gamers to earn free games while using their platform.

### SUMMARY

Computer-implemented methods and systems are provided that distribute media content items using a distributed ledger maintained by a plurality of nodes. Specifically, first data is stored in the distributed ledger. The first data represents a purchase contract that transfers a digital token associated with a particular digital media content item to a first user in return for payment by the first user. The payment made by the first user can be in the form of cryptocurrency, fiat currency, store credit or some other value. Second data is also stored in the distributed ledger. The second data represents a resale contract that transfers the digital token associated with the particular digital media content and stored as part of the first data from the first user to a second user in return for payment of by the second user. The payment made by the second user can be in the form of cryptocurrency, fiat currency, store credit or some other value.

In embodiments, the digital token associated with the particular digital media content item as part of the first data grants only the first user permission to access the particular digital media content item unless such digital token is transferred from the first user to another user by data representing a resale contract that is stored in the digital ledger. Similarly, the digital token associated with the particular digital media content item as part of the second data grants only the second user permission to access to the particular digital media content item unless such digital token is transferred from the second user to another user by data representing a resale contract that is stored in the digital ledger.

In embodiments, the first data can be added to the distributed ledger by consensus of the plurality of nodes, and the second data can be added to the distributed ledger by consensus of the plurality of nodes.

In embodiments, the digital ledger can be a blockchain. In this embodiment, the first data can be validated by the plurality of nodes for addition to respective pools maintained by the plurality of nodes. The first data can be selected from a pool for mining and added to a new block that is linked to an earlier block as part of the distributed ledger. The second data can also be validated by the plurality of nodes for addition to the respective pools maintained by the plurality of nodes. The second data can be selected from a pool and added to another new block that is linked to an earlier block as part of the blockchain.

In embodiments, the terms of the purchase contract can be specific to the particular media content item and invoked by a plurality of purchase messages that are propagated by the plurality of nodes and stored in the distributed ledger. The terms of the resale contract can be specific to the particular media content item and invoked by a plurality of resale messages that are propagated by the plurality of nodes and stored in the distributed ledger.

In embodiments, the first data can be generated by sending a message originating from an address of the first user to the assigned first address, and the second data can be generated by sending a message originating from an address of the second user to the assigned second address.

The methods and systems can further involve selectively permitting a user to access a specific digital media content item by checking that an address of the user holds a digital token corresponding to the specific digital media content item as represented by the current state of the distributed ledger. The access to the particular digital media content item can involve downloading data representing the particular media content item.

In embodiments, the methods and systems can maintain a user-specific wallet account storing information associated with a wallet address of the user, wherein such information includes data representing each digital token that is held by the user and corresponding to a given digital media content item as represented by current state of the distributed ledger. The address checking that controls user access can involve checking the user-specific wallet account to verify that the user-specific wallet account stores data representing a valid digital token that is held by the user for the specific digital media content item.

In embodiments, the purchase contract can be invoked by a purchase message that identifies the wallet address of the first user (buyer) as the recipient of the digital token and that includes a digital signature derived from a private key of the first user (buyer). The purchase message can be validated by verifying that the digital signature included in the purchase message corresponds to a wallet address of the first user (buyer). The validation of the purchase message can provide for effective electronic authorization by the service provider entity (or service administrator or publisher entity) of the issuance of the digital token to the first user (buyer). The execution of the purchase contract can create the digital token associated with the particular digital media content item and assign such digital token to the first user (buyer). The execution results of the purchase contract can be stored in the distributed ledger. In response to storing the execution results of the purchase contract in the distributed ledger, the digital token associated with the particular digital media content item can be added to the wallet account of the first user (buyer).

In embodiments, the purchase contract can be invoked by a purchase message that identifies the wallet address of the first user (buyer) as the recipient of the digital token and that includes a digital signature derived from a private key of a participant seller (such as). The purchase message can be validated by verifying that the digital signature included in the purchase message corresponds to the wallet address of the participant seller. Such digital signature verification provides for electronic authorization by the participant seller of the issuance of the digital token to the first user (buyer). The execution of the purchase contract can create the digital token associated with the particular digital media content item and assign such digital token to the first user (buyer). The execution results of the purchase contract can be stored in the distributed ledger. In response to storing the execution results of the purchase contract in the distributed ledger, the digital token associated with the particular digital media content item can be added to the wallet account of the first user (buyer).

In embodiments, the purchase message can be used to invoke the purchase contract in many different scenarios, such as upon action or input from the first user (buyer), upon successful verification that the first user (buyer) has properly paid for the digital token, or upon other circumstances.

In embodiments, the resale contract can be invoked by a resale message that identifies the wallet address of the second user (buyer) as the recipient of the digital token and that includes a digital signature derived from a private key of the first user (seller). The resale message can be validated by verifying that the digital signature included in the resale message corresponds to a wallet address of the first user (seller). Such digital signature verification provides for electronic authorization by the first user (seller) of the transfer of the digital token held by the first user. The execution of the resale contract can transfer the digital token associated with the particular digital media content item from the first user (seller) to the second user (buyer). The execution results of the resale contract can be stored in the distributed ledger. In response to storing the execution results of the resale contract in the distributed ledger, the digital token associated with the particular digital media content item can be removed from the wallet account of the first user (seller) and added to the wallet address of the second user (buyer).

In embodiments, the methods and systems can maintain a user-specific hold account storing information associated with a wallet address of the user, wherein such information includes data representing each digital token that is held by the user and corresponding to a given digital media content item as represented by current state of the distributed ledger and that has been offered or otherwise designated for resale by the user. The address checking that controls user access can further involve checking the user-specific hold account to verify that the user-specific hold account stores data representing a valid digital token that is held by the user for the specific digital media content item.

In embodiments, the resale contract can be invoked by a resale message that identifies the wallet address of the second user (buyer) as the recipient of the digital token and that includes a digital signature derived from a private key of the first user (seller). The resale message can be validated by verifying that the digital signature included in the resale message corresponds to the hold account wallet address of the first user (seller). Such digital signature verification provides for electronic authorization by the first user (seller) of the transfer of the digital token held by the first user (seller). The execution of the resale contract can transfer the digital token associated with the particular digital media content item from the first user (seller) to the second user (buyer). The execution results of the resale contract can be stored in the distributed ledger. In response to storing the execution results of the resale contract in the distributed ledger, the digital token associated with the particular digital media content item can be removed from the user-specific hold account of the first user (seller) and added to the wallet address of the second user (buyer).

In other embodiments, the methods and systems can maintain a service-controlled (or administrator-controlled) hold account storing data representing the digital tokens that are held by users and corresponding to digital media content items as represented by current state of the distributed ledger that have been offered or otherwise designated for resale by users. The address checking that controls user access can further involve checking the service-controlled hold account to verify that the service-controlled hold account stores data representing a valid digital token that is held by the user for the specific digital media content item.

In embodiments, the resale contract can be invoked by a resale message that identifies the wallet address of the second user (buyer) as the recipient of the digital token and that includes a digital signature derived from a private key of a participant seller (such as the service provider entity or service administrator or publisher entity). The resale message can be validated by verifying that the digital signature included in the purchase message corresponds to the wallet address of the participant seller. Such digital signature verification provides for electronic authorization by the participant seller of the transfer of the digital token. The execution of the resale contract can transfer the digital token associated with the particular digital media content item to the second user (buyer). The execution results of the resale contract can be stored in the distributed ledger. In response to storing the execution results of the resale contract in the distributed ledger, the digital token associated with the particular digital media content item can be removed from the service-controlled hold account and added to the wallet address of the second user (buyer).

In embodiments, the resale message can be used to invoke the resale contract in many different scenarios, such as upon action or input from the second user (buyer), upon successful verification that the second user (buyer) has properly paid for the digital token, or upon other circumstances.

In embodiments, the purchase contract of the first data can transfer some portion of the payment made by the first user (buyer) to an address for a service provider entity. The purchase contract of the first data can also transfer another portion of the payment made by the first user (buyer) to an address for an entity that published the particular media content item.

In embodiments, the resale contract of the second data can transfer some portion of the payment made by the second user (buyer) to an address for a service provider entity. The resale contract of the second data can also transfer another portion of the payment made by the second user (buyer) to an address for an entity that published the particular media content item. The resale contract of the second data can also transfer some other portion of the payment made by the second user (buyer) to an address for the first user.

In embodiments, the digital media content items are selected from the group consisting of online video games, other online games, audio files, video files, image files, electronic books, document files, other digital media, and combinations thereof.

### BRIEF DESCRIPTION OF THE DRAWINGS

FIG. 1 is a block diagram illustrating a media content distribution system according to an embodiment of the present disclosure.

FIG. 2 is an activity diagram that illustrates exemplary operations carried out by the system components of FIG. 1 to invoke a purchase contract for a particular media content item.

FIG. 3 is an activity diagram that illustrates exemplary operations carried out by the system components of FIG. 1 to invoke a resale contract for a particular media content item according to an embodiment of the present disclosure.

FIG. 4 is an activity diagram that illustrates exemplary operations carried out by the system components of FIG. 1 to selectively grant permission to an end user device to access a particular media content item according to the embodiment of FIG. 3.

FIG. 5 is an activity diagram that illustrates exemplary operations carried out by the system components of FIG. 1 to invoke a resale contract for a particular media content item according to another embodiment of the present disclosure.

FIG. 6 is an activity diagram that illustrates exemplary operations carried out by the system components of FIG. 1 to selectively grant permission to an end user device to access a particular media content item according to the embodiment of FIG. 5.

FIG. 7A is a block diagram illustrating a network of ledger nodes that maintain a distributed ledger according to an embodiment of the present disclosure.

FIG. 7B is a schematic illustration of an exemplary sequence of blocks of the distributed ledger maintained by the ledger nodes of FIG. 7A according to an embodiment of the present disclosure.

FIG. 8 is a block diagram illustrating additional features of the online transaction system for configuring an end user device to join a mining pool as part of the media content distribution system of FIG. 1.

FIG. 9 is a block diagram illustrating additional features of the media content distribution system of FIG. 1.

FIG. 10 is a component block diagram illustrating a computer system suitable for use in the various embodiments.

### DETAILED DESCRIPTION OF THE PREFERRED EMBODIMENTS

Herein, the term “IRON” may be used to refer to a cryptocurrency used in conjunction with the digital media distribution platform described herein. IRON may also be referred to as “IRON tokens,” which may be used to make a purchase within the platform and may be received as a result of making a sale, including resales, within platform. It should be noted that IRON may be purchased from a third-party money transmitter in exchange for payment (e.g., cash, credit card, check, etc.). For example, the third-party money transmitter may initiate a transaction to a credit card of a buyer and, in return, initiate a transfer of a corresponding amount of IRON to an address of a digital wallet of the buyer.

Herein, the term “message” is a unit of information transmitted electronically from one device to another over a communication network. The transmission of a message can employ communication protocols, such as the web3.js library employed by the Ethereum blockchain, which provides for communication from one device to another through remote procedure calls.

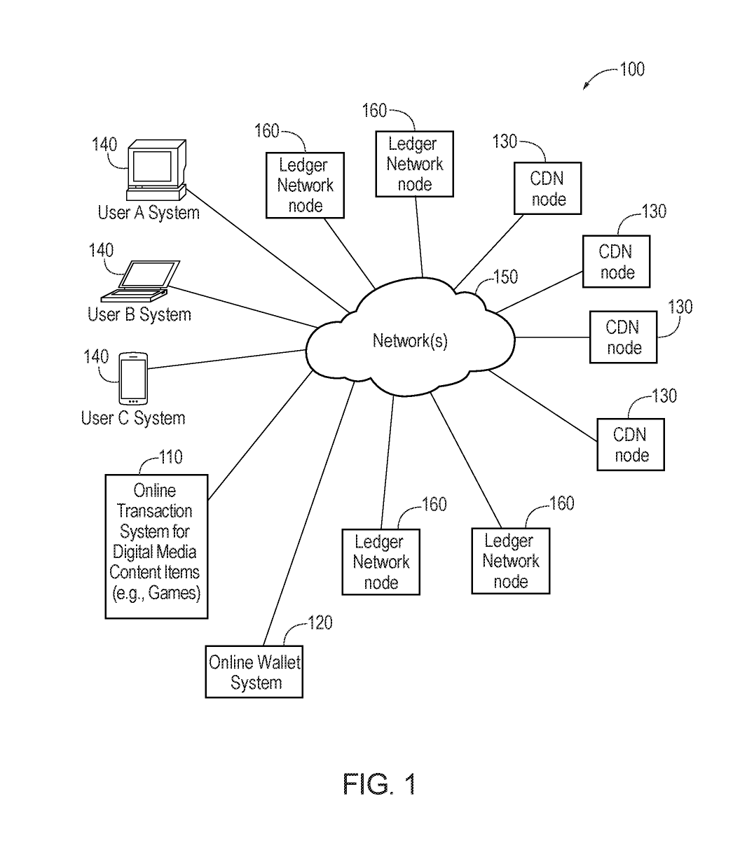

FIG. 1 illustrates one embodiment of a service (or platform) 100 for distributing digital media content items, such as on-line games. The service 100 includes an online transaction system 110 and an online wallet system 120, which are centralized or decentralized computer systems that are operated by a service provider and connected to one another through one or more communication network(s) 150, such as the Internet, a local or wide area network (LAN or WAN), or the like. The service also includes a number of content distribution nodes 130, which are centralized or decentralized computer systems that are operated by the service provider or by a third party on behalf of the service provider and connected to the communication network(s) 150. The service 100 makes digital media content items (e.g., on-line games) available to end users that operate devices 140 that are connected to the communication network(s) 150. The device 140 are user computing devices such as a personal computer (PC), notebook, workstation, smartphone, or other computing device. Each network-connected device 140 can include at least one processor and a memory. Each network-connected device 140 can also include an output device, such as a display screen or monitor, and an input device, such as a keyboard, keypad, mouse, touchpad, screen input and/or the like.

The online transaction system 110 can be implemented with a computer system that may include one or more physical servers and/or other computing machines (not shown). The online transaction system 110 is typically in the form of a web site hosted on a server system that is connected to the communication network(s) 150. The online transaction system 110 provides a marketplace of digital media content items, such as on-line games, that the end users can browse, purchase and possibly resell, if desired, as described below in more detail. The online transaction system 110 can also provide an authentication service that allows end users to log in to an account. Logging in can enable additional features by allowing the online transaction system 110 to track users' actions and/or make purchases and/or resale offers.

A user may join the platform 100 by accessing a particular website (URL) and registering. Registering may include receiving a wallet address and a private key, unique to the user. The private key may be stored by the online wallet system 120 or separately by the user, for example in cold storage. In some instances, a user may utilize separate wallets for separate transactions. The user's registration may be validated by the user logging into the platform via a link transmitted to the user's electronic device or email.

The online wallet system 120 can be implemented with a computer system that may include one or more physical servers and/or other computing machines (not shown). The online wallet system 120 is also typically in the form of a web site hosted on a server system that is connected to the communication network(s) 150. Parts of all of the online wallet system 120 can be implemented with a computing system that also implements the online transaction system 110 (or part thereof).

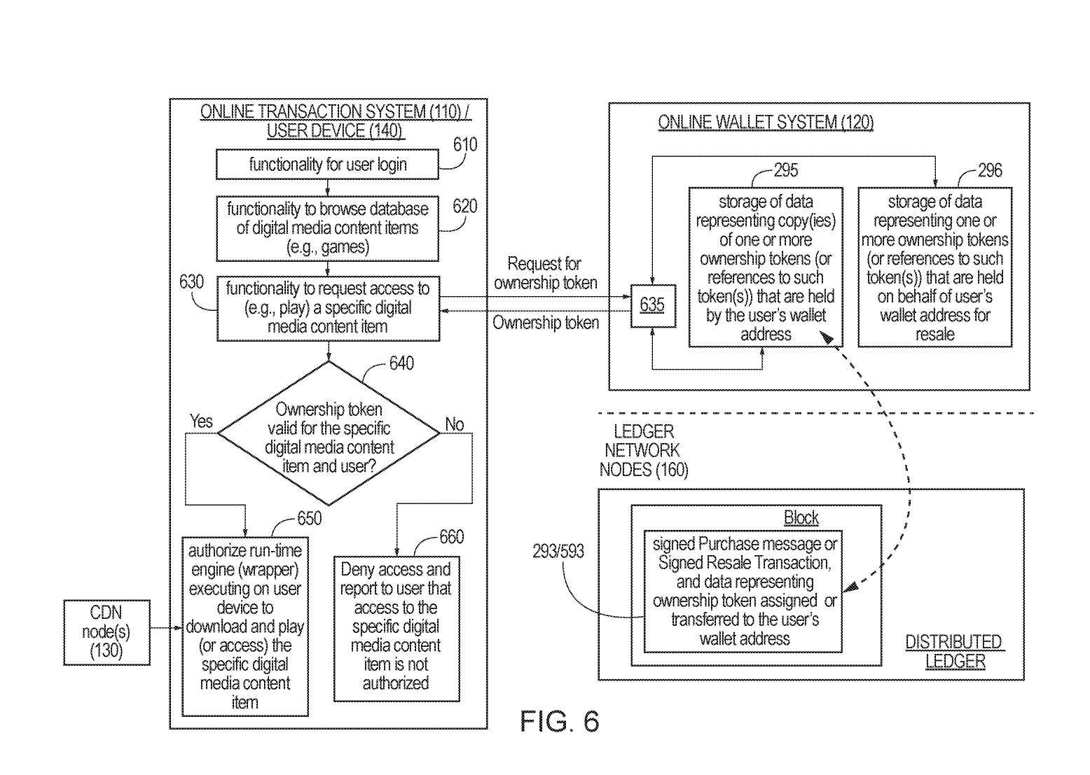

The online wallet system 120 works in conjunction with a distributed ledger maintained by a network of nodes 160 (which are also referred to herein as “ledger network nodes” or “ledger nodes”) connected through the one or more communication network(s) 150. The ledger nodes 160 are networked computer systems. In embodiments, a subset of the ledger nodes 160 can be operated by the service provider, while another subset of the ledger nodes can be operated by third parties and/or end user systems (FIG. 6). The distributed ledger is a ledger of transactions and contracts maintained in decentralized form by different computer systems across different locations and entities. The transactions and contracts can transfer cryptocurrency (e.g., IRON) and/or other forms of payment and related contractual rights and obligations between participants. The addition of transactions and contracts to the distributed ledger over time is governed by rules of the network that minimize trust between the participants and thus eliminate the need of one or more central trusted authorities to check against manipulation and fraud with respect to the transactions and contracts. As the transactions and contracts are added to the ledger, they become immutable. Note that while centralized ledgers are prone to cyber-attack, distributed ledgers are inherently harder to attack because all the distributed copies need to be attacked simultaneously for an attack to be successful. Further, the distributed ledger of transactions and contracts is resistant to malicious changes by a single party.

The online wallet system 120 stores accounts (referred to herein as “wallet accounts”) for the end users, assigns an address (derived from an assigned public key) and corresponding private key to the account for each end user, and stores the address and possibly the corresponding private key assigned to each end user account. The address and private key of a respective end user can be used to transfer (or spend) cryptocurrency (e.g., IRON) or other forms of payment and digital tokens (referred to herein as “ownership tokens”) held by the respective end user as part of the current state of the distributed ledger maintained by the ledger nodes 160. Furthermore, the address of the respective end user can be used to receive cryptocurrency (e.g., IRON) or other forms of payment and ownership token(s) by the respective end user from another user (or other entity) as part of the current state of the distributed ledger maintained by the ledger nodes 160. The online wallet system 120 can also provide an authentication service that allows end users to log in to and access the appropriate account. The same authentication service can be shared between the online transaction system 110 and the online wallet system 120.

The online wallet system 120 of a user can be secured with a password and possibly multifactor authentication. The online wallet system 120 can be compatible with hardware wallets and other well-regarded wallets like Coinbase. The online wallet system 120 can be used to generate a random private key for a user based on seeds stored by online wallet system 120. Such seeds can be stored as off-chain records allow for advanced account recovery of the content of a wallet in case any user ever loses his or her private key. In embodiments, the private key for each user is used to derive elliptic curve digital signatures for authenticating messages originating from the user. The user's private key can be loaded and stored as part of the user's wallet. The user's private key as stored by the online wallet system 120 can be used to digitally sign messages (transactions or calls) made by the user for authentication purposes. Alternatively, the user can store his or her private key in a hardware wallet or other form of storage. In this case, the user can be required to employ the hardware wallet (or provide the user's private key) to digitally sign messages (transactions or calls) made by the user for authentication purposes.

The content distribution nodes 130 are nodes of a content distribution network which are connected to the end-user devices 140 through the one or more communication network(s) 150, such as the Internet, a local or wide area network (LAN or WAN), or the like. The content distribution nodes 130 are configured to store copies of the digital media content items, e.g., on-line games (or portions thereof) included in the marketplace of digital media content items provided by the online transaction system and to deliver such copies to the end user devices as appropriate. Typically, such delivery involves caching and/or transmission and/or streaming of the digital media content items (or portions thereof). The copies of the digital media content items (or parts thereof) can be stored by the content distribution nodes 130 using DRM security features and also transmitted (or streamed) in such secure form over the communication network(s) 150. In this case, the user devices 140 can be configured with capabilities to unlock the DRM security features of the digital media content items (or parts thereof) as necessary. The content distribution nodes 130 can be realized by a set of dedicated servers and/or possibly a peer-to-peer network of nodes connected in an ad-hoc manner.

The online transaction system 110 provides functionality that allows an end user (referred to as a Buyer) to select and initiate a purchase of an ownership token for a particular digital media content item (e.g., a particular online game) provided in its marketplace of digital media content items. Such purchase utilizes an amount of cryptocurrency (e.g., IRON) or other form of payment held by the Buyer by association with the Buyer's wallet address as part of the current state of the distributed ledger maintained by the ledger nodes 160.

In some cases, the purchase action by the Buyer can trigger the generation of a Purchase message specific to the particular digital media content item (e.g., a Purchase transaction specific to the particular digital media content item or call to a Purchase contract specific to the particular digital media content item). The Purchase message is transmitted and propagated across the ledger nodes 160. The Purchase message invokes the terms of the Purchase contract specific to the particular digital media content item, which when executed generates or creates an ownership token for the particular digital media content item and transfers the ownership token to the Buyer (via the Buyer's wallet address). The Purchase contract is a set of software functions or other programming constructs that are stored as part of the distributed ledger maintained by the ledger nodes 160 and that operate to provide a computer protocol that facilitates, verifies and enforces the performance of a contract that generates or creates an ownership token and transfers the ownership token to the Buyer (via the Buyer's wallet address). The ownership token is a digital token that controls permission to access a digital media content item associated with the digital token. When the ownership token is held by the Buyer by association with the Buyer's wallet address, the ownership token grants only the Buyer (through the Buyer's wallet address) permission to access the digital media content item associated with the ownership token unless such ownership token is transferred from the Buyer to another user by the invocation of a follow-on Resale contract as described below.

In other cases, the Purchase message can be used to invoke the Purchase contract in other scenarios, such as upon successful verification that the Buyer has properly paid for the ownership token or upon other circumstances.

The Purchase message can include one or more of the following data: the Buyer's wallet address, a signature derived from the private key of the Buyer, the wallet address of a participant seller that is selling the ownership token (which can be the service provider or the publisher of the particular digital media content item), and a signature derived from the private key of the participant seller. The Buyer's wallet address identifies the intended recipient of the ownership token for the particular digital media content item. The signature derived from the private key of the Buyer can be verified against the Buyer's wallet address (public key) to verify that the Buyer has authorized the Purchase message and its actions, particularly the transfer of cryptocurrency or other form of payment from the Buyer. The signature derived from the private key of the participant seller can be verified against the participant seller's wallet address (public key) to verify that the participant seller has authorized the Purchase message and its actions, particularly the creation of the ownership token for the particular digital media content item and the transfer of such ownership token to the Buyer (via the Buyer's wallet address). The Purchase message can also specify other data items for input to the Purchase contract, such as the purchase price for ownership token and the percentage of the purchase price to transfer to various participants (such as the service provider and publisher of the particular digital media content item). The Purchase message is transmitted and propagated across the ledger nodes 160.

The execution of the Purchase contract can transfer cryptocurrency (e.g., IRON) or other form of payment from the Buyer's wallet based on the purchase price of the ownership token and can also transfer cryptocurrency (e.g., IRON) or other form of payment to various participants based on the purchase price of the ownership token. For example, the purchase price of ownership token in cryptocurrency or other form of payment can be transferred from the Buyer's wallet address, a part (e.g. 5%) of the purchase price of the ownership token in cryptocurrency or other form of payment can be transferred to a wallet address for the service provider, and another part (e.g., 95%) of the purchase price of the ownership token in cryptocurrency or other form of payment can be transferred to a wallet address for the publisher of the particular digital media content item. In this manner, the execution of the Purchase contract can split the purchase price for the ownership token in the cryptocurrency (e.g., IRON) or other form of payment between the service provider and the publisher of particular digital media content item.

In other embodiments, one or more data items that are input to the Purchase contract can be provided by an oracle that acts as a third-party data feed during execution of the Purchase contract. Such data items can include the full purchase price for an ownership token for the particular digital media content item and the percentage of the full purchase price to transfer to various participants (such as the service provider and publisher of the particular digital media content item). Such data items can be stored in the digital ledger (or possibly in some other data store) and accessed by the oracle during execution of the Purchase contract. It is contemplated that these data items might change over time with respect to a particular digital media content item as deemed appropriate by the publisher and/or service provider.

The ledger nodes 160 can maintain a pool of pending messages (transactions and contract calls) that are received over time. Each ledger node 160 that receives the Purchase message can add the Purchase message to its pool of pending messages. A miner node (which is one of the ledger nodes 160) can select a number of pending messages from its pool (which can include the Purchase message) and validate the selected messages. The miner node can execute the contracts that are referenced or called by the valid selected messages (including the execution of the Purchase contract when selected). The results from the above executions will change the balances of accounts and the data stored with the Purchase contract (including the generation of new contract code). The validated messages and updated data are packaged into a block and a proof of work algorithm or puzzle is applied to the block. If the proof of work algorithm or puzzle is solved by the mining node, the mining node can broadcast this new block across the ledger nodes 160 of the network. Multiple miner nodes can compete against one another to solve for a new block and broadcast the new block across the ledger nodes 160 of the network.

Each ledger node 160 that receives this broadcasted new block can validate the new block and executes the contracts that are referenced or called by the messages of the new block (including the execution of the Purchase contract) in the order specified by the new block, and record the resulting changes. Each ledger node 160 can verify that the new block as valid and if so, adds the data for the new block to its copy of the distributed ledger.

Note that a reward of cryptocurrency (e.g., IRON) can be given to the operator of the mining node that is first to form a new valid block, which can be enforced through consensus of the ledger nodes 160 in validating the new blocks broadcast by the miner nodes.

In alternate embodiments, a mining node can be selected to form or mine the new block in a deterministic way depending on its wealth or stake. This is referred to as proof-of-stake mining. In this case, there is typically no reward for mining the new block, but the mining node receives transaction fees.

With the Purchase message (and execution results of the corresponding Purchase contract) stored as part of the state of the distributed ledger, the online wallet system 120 (or some other data store controlled by the service provider) can store a copy of the ownership token for the particular digital media content item (which results from the execution of the corresponding Purchase contract) as part of the Buyer's wallet account. In other words, the copy of the ownership token for the particular digital media content item can be stored and associated with the Buyer's wallet address.

Furthermore, the copy of the ownership token for the particular digital media content item stored and associated with the Buyer's wallet address can be checked to give the Buyer rightful access to delivery of the particular digital media content item from the CDN nodes 130. Specifically, the ownership token can be required to request delivery (or perfect delivery) of the particular digital media content item from the CDN nodes 130 and unlock the DRM security features of the particular digital media content item as delivered from the CDN nodes 130.

The online transaction system 110 can also provide functionality that allows an end user (referred to as a Seller) to offer or otherwise designate for resale the ownership token for a particular digital media content item that is held by the Seller by association with the Seller's wallet address. Furthermore, the online transaction system 110 can also provide functionality that allows the Seller to specify a percentage or amount of the purchase price for the ownership token that will be paid to the Seller's wallet address upon resale of the ownership token. This is referred to herein as the “Seller's commission.” The Seller's commission can vary according to input from the Seller (such as by operation of slider bar or other suitable input mechanism). Note that any message that transfers the ownership token held by the Seller to another user by a Resale contract can require a signature derived from the private key of the Seller (or possibly a signature derived from the private key of other participant authorized by the Seller).

In this embodiment, data representing that such ownership token has been designated for resale and possibly data representing the Seller's commission can be stored as part of the Seller's wallet account (or in some other data store, such as a data store maintained by the service provider).

Note that multiple users might possibly have offered for resale an ownership token for the same digital media content item. In this case, data representing such ownership tokens and possibly the data representing the corresponding Sellers' commissions can be processed (which can possibly involve ranking the Sellers and corresponding ownership tokens based on the lowest Seller's commission) to select one of the available ownership tokens to be resold to a Buyer of the corresponding digital media content item. Other mechanisms, such as barter or auction or exchange services, can also be used to match the Buyer (via the Buyer's wallet address) to the Seller (via the Seller's wallet address).

In this case, the purchase action of the Buyer can trigger the generation of a Resale message specific to the particular digital media content item (e.g., a Resale transaction or call to a Resale contract specific to the particular digital media content item). The Resale message is transmitted and propagated across the ledger nodes 160. The Resale message invokes the terms of the Resale contract specific to the particular digital media content item, which when executed transfers the ownership token for the particular digital media content item from the Seller (via the Seller's wallet address) to the Buyer (via the Buyer's wallet address). The Resale contract is a set of software functions or other programming constructs that are stored as part of the distributed ledger maintained by the ledger nodes 160 and that operate to provide a computer protocol that facilitates, verifies and enforces the performance of a contract that transfers an ownership token from the Seller (via the Seller's wallet address) to the Buyer (via the Buyer's wallet address). When the ownership token is held by the Buyer by association with the Buyer's wallet address, the ownership token grants only the Buyer (through the Buyer's wallet address) permission to access the digital media content item associated with the ownership token unless such ownership token is transferred from the Buyer to another user by the invocation of a follow-on Resale contract.

In other cases, the Resale message can be used to invoke the Resale contract in other scenarios, such as upon successful verification that the Buyer has properly paid for the ownership token or upon other circumstances.

The Resale message can include one or more of the following data: the Buyer's wallet address, a signature derived from the private key of the Buyer, the Seller's wallet address, and a signature derived from the private key of the Seller. The Buyer's wallet address identifies the intended recipient of the ownership token for the particular digital media content item. The signature derived from the private key of the Buyer can be verified against the Buyer's wallet address (public key) to verify that the Buyer has authorized the Resale message and its actions, particularly the transfer of cryptocurrency or other form of payment from the Buyer. The signature derived from the private key of the Seller can be verified against the Seller's wallet address (public key) to verify that the Seller has authorized the Resale message and its actions, particularly the transfer of such ownership token from the Seller (via the Seller's wallet address) to the Buyer (via the Buyer's wallet address). The signature derived from the Buyer's private key can be generated by input of the Buyer. The signature derived from the Seller's private key can be generated by input of the Seller or some other participant authorized by the Seller. The Resale message can also specify other data items for input to the Resale contract, such as the Seller's commission, the purchase price for the ownership token, and the percentage of the purchase price to transfer to various participants (such as the service provider and publisher of the particular digital media content item).

The execution of the Resale contract can transfer cryptocurrency (e.g., IRON) or other form of payment from the Buyer's wallet based on the purchase price of the ownership token and can transfer cryptocurrency (e.g., IRON) or other form of payment to various participants based on the purchase price of the ownership token. For example, the purchase price of the ownership token in cryptocurrency or other form of payment can be transferred from the Buyer's wallet address, a part (e.g. 5%) of the purchase price of the ownership token in cryptocurrency or other form of payment can be transferred to a wallet address for the service provider, another part (e.g., 70%) of the purchase price of the ownership token in cryptocurrency or other form of payment can transferred to a wallet address for the publisher of particular digital media content item, and the Seller's commission can be transferred to the Seller's wallet address. In this manner, the execution of the Resale contract can split the purchase for the ownership token in cryptocurrency or other form of payment between the service provider, the publisher of particular digital media content item, and the Seller.

Note that in some instances where the Seller's commission is less than an allowed maximum Seller's commission (for example, less than 25% of the purchase price for an ownership token for the particular digital media content item), the effective price that the Buyer pays for the ownership token can be reduced by the difference between the Seller's commission and the allowed maximum Seller's commission.

In other embodiments, one or more data items that are input to the Resale contract can be provided by an oracle that acts as a third-party data feed during execution of the Resale contract. Such data items can include the full purchase price for an ownership token for the particular digital media content item and the percentage of the full purchase price to transfer to various participants (such as the service provider and publisher of the particular digital media content item). Such data items can be stored in the digital ledger (or possibly in some other data store) and accessed by the oracle during execution of the Resale contract. It is contemplated that these data items might change over time with respect to a particular digital media content item as deemed appropriate by the publisher and/or service provider.

In this embodiment, each ledger node 160 that receives the Resale message can add the Resale message to the pool of pending messages. A miner node (which is one of the ledger nodes 160) can select a number of pending messages from the pool (which can include the Resale message) and validate the selected messages. The miner node can execute the contracts that are referenced or called by the valid selected messages (including the execution of the Resale contract when selected). The results from the above executions will change the balances of accounts and the data stored with the Resale contract (including the generation of new contract code). The validated messages and updated data are packaged into a block and a proof of work algorithm or puzzle is applied to the block. If the proof of work algorithm or puzzle is solved by the mining node, the mining node broadcasts this new block across the ledger nodes 160 of the network. Multiple miner nodes can compete against one another to solve for a new block and broadcast the new block across the ledger nodes 160 of the network.

Each ledger node 160 that receives this broadcasted new block can validate the new block and execute the contracts that are referenced or called by the messages of the new block (including the execution of the Resale contract) in the order specified by the new block, and records the resulting changes. Each ledger node 160 can verify that the new block as valid and if so, add the data for the new block to its copy of the distributed ledger.

Note that a reward of cryptocurrency (e.g., IRON) can be given to the operator of the mining node that is first to form a new valid block, which can be enforced through consensus of the ledger nodes 160 in validating the new blocks broadcast by the miner nodes.

In alternate embodiments, a mining node can be selected to form or mine the new block in a deterministic way depending on its wealth or stake. This is referred to as proof-of-stake mining. In this case, there is typically no reward for mining the new block, but the mining node receives transaction fees.

With the Resale message (and the execution results of the corresponding Resale contract) stored as part of the state of the distributed ledger, the online wallet system 120 can remove the copy of the ownership token for the particular digital media content item stored as part of the Seller's wallet account. In other words, the copy of the ownership token for the particular digital media content item is removed from storage in association with the Seller's wallet address. In effect, this forbids or denies the Seller rightful access to delivery and subsequent use of the particular digital media content item from the CDN nodes 130. Furthermore, the online wallet system 120 (or other data store operated by the service provider) can store a copy of the ownership token for the particular digital media content item associated with the Buyer's wallet address.

Furthermore, the copy of the ownership token as stored and associated with the Buyer's wallet address can be checked to give the Buyer rightful access to delivery of the particular digital media content item from the CDN nodes 130. Specifically, the ownership token can be required to request delivery (or perfect delivery) of the particular digital media content item from the CDN nodes 130 and unlock the DRM security features of the particular digital media content item as delivered from the CDN nodes 130.

In another embodiment, data representing a user's ownership token that has been offered or otherwise designated by the user (Seller) for resale, and possibly data representing the associated Seller's commission, can be stored on behalf of the Seller as part of a “hold” account for the Seller. The “hold” account for the Seller is configured to hold data pertaining to the ownership token(s) of the Seller that have been offered or otherwise designated for resale by the Seller. The “hold” account for the Seller can be maintained by the online wallet system 120 or possibly in some other data store maintained by the service provider. Note that any message that transfers an ownership token held in the Seller's hold account to another user via a Resale contract requires a signature based on the private key of a participant seller (such as the service provider entity or administrator or publisher of the particular content item). The private key of the participant seller can be maintained by the online wallet system 120 or possibly in some other data store maintained by the service provider such that it is available when needed. The Seller's “hold” account is a form of escrow account where the ownership token is held by the participant seller for the benefit of the Seller. The Seller “hold” account is designed to minimize any delay in transferring the ownership token held by Seller to another user via resale, where such delay might occur because the Seller is unavailable and thus cannot provide input that is required to generate an appropriate signature derived from the Seller's private key.

Note that multiple users might possibly have offered for resale an ownership token for the same digital media content item. In this case, data representing such ownership tokens and possibly the data representing the corresponding Sellers' commissions can be stored in different hold accounts for the different users and processed (which can possibly involve ranking the Sellers and corresponding ownership tokens based on the lowest Seller's commission) to select one of the available ownership tokens to be resold to a Buyer of the corresponding digital media content item. Other mechanisms, such as barter or auction or exchange services, can also be used to match the Buyer (via the Buyer's wallet address) to the Seller (via the Seller's wallet address).

In this embodiment, the purchase action of the Buyer can trigger the generation of a Resale message specific to the particular digital media content item (e.g., a Resale transaction or call to a Resale contract specific to the particular digital media content item). The Resale message can include one or more of the following data: the Buyer's wallet address, a signature derived from the private key of the Buyer, a wallet address of the participant seller, and a signature derived from the private key of the participant seller. The Buyer's wallet address identifies the intended recipient of the ownership token for the particular digital media content item. The signature derived from the private key of the Buyer can be verified against the Buyer's wallet address (public key) to verify that the Buyer has authorized the Resale message and its actions, particularly the transfer of cryptocurrency or other form of payment from the Buyer. The signature derived from the private key of the participant seller can be verified against the participant seller's wallet address (public key) to verify that the participant seller has authorized the Resale message and its actions, particularly the transfer of such ownership token from the Seller (via the Seller's hold account) to the Buyer (via the Buyer's wallet address). The Resale message can also specify other data items for input to the Resale contract, such as the Seller's commission, the purchase price for the Seller's ownership token, and the percentage of the purchase price to transfer to various participants (such as the service provider and publisher of the particular digital media content item). The Resale message is transmitted and propagated across the ledger nodes 160. The Resale message invokes the terms of the Resale contract specific to the particular digital media content item, which when executed transfers the ownership token for the particular digital media content item from the Seller (via the Seller's hold account) to the Buyer (via the Buyer's wallet address). When the ownership token is held by the Buyer by association with the Buyer's wallet address, the ownership token grants only the Buyer (through the Buyer's wallet address) permission to access the associated digital media content item unless such ownership token is transferred from the Buyer to another user by the invocation of a follow-on Resale contract.

The execution of the Resale contract can also transfer cryptocurrency (e.g., IRON) or other form of payment from the Buyer's wallet based on the purchase price of the ownership token and can also transfer cryptocurrency (e.g., IRON) or other form of payment to various participants based on the purchase price of the ownership token. For example, the purchase price of the ownership token in cryptocurrency or other form of payment can be transferred from the Buyer's wallet address, a part (e.g. 5%) of the purchase price of the ownership token in cryptocurrency or other form of payment can be transferred to a wallet address for the service provider, another part (e.g., 70%) of the purchase price of the ownership token in cryptocurrency or other form of payment can transferred to a wallet address for the publisher of particular digital media content item, and the Seller's commission can be transferred to the Seller's wallet address. In this manner, the execution of the Resale contract can split the purchase price for the ownership token in the cryptocurrency (e.g., IRON) or other form of payment between the service provider, the publisher of particular digital media content item, and the Seller.

Note that in some instances where the Seller's commission is less than an allowed maximum Seller's commission (for example, less than 25% of the purchase price for an ownership token for the particular digital media content item), the effective price that the Buyer pays for the ownership token can be reduced by the difference between the Seller's commission and the allowed maximum Seller's commission.

In other embodiments, one or more data items that are input to the Resale contract can be provided by an oracle that acts as a third-party data feed during execution of the Resale contract. Such data items can include the full purchase price for an ownership token for the particular digital media content item and the percentage of the full purchase price to transfer to various participants (such as the service provider and publisher of the particular digital media content item). Such data items can be stored in the digital ledger (or possibly in some other data store) and accessed by the oracle during execution of the Resale contract. It is contemplated that these data items might change over time with respect to a particular digital media content item as deemed appropriate by the publisher and/or service provider.

In this embodiment, each ledger node 160 that receives the Resale message can add the Resale message to its pool of pending messages. A miner node (which is one of the ledger nodes 160) can select a number of pending messages from its pool (which can include the Resale message) and validate the selected messages. The miner node can execute the contracts that are referenced or called by the valid selected messages (including the execution of the Resale contract when selected). The results from the above executions will change the balances of accounts and the data stored with the Resale contract (including the generation of new contract code). The validated messages and updated data are packaged into a block and a proof of work algorithm or puzzle is applied to the block. If the proof of work algorithm or puzzle is solved by the mining node, the mining node broadcasts this new block across the ledger nodes 160 of the network. Multiple miner nodes can compete against one another to solve for a new block and broadcast the new block across the ledger nodes 160 of the network.

Each ledger node 160 receiving this broadcasted new block can validate the new block and execute the contracts that are referenced or called by the messages of the new block (including the execution of the Resale contract) in the order specified by the new block, and record the resulting changes. Each ledger node 160 can verify that the new block as valid and if so, add the data for the new block to its copy of the distributed ledger.

Note that a reward of cryptocurrency (e.g., IRON) can be given to the operator of the mining node that is first to form a new valid block, which can be enforced through consensus of the ledger nodes 160 in validating the new blocks broadcast by the miner nodes.

In alternate embodiments, a mining node can be selected to form or mine the new block in a deterministic way depending on its wealth or stake. This is referred to as proof-of-stake mining. In this case, there is typically no reward for mining the new block, but the mining node receives transaction fees.

With the Resale message (and the execution results of the corresponding Resale contract) stored as part of the state of the distributed ledger, the online wallet system 120 can remove the copy of the ownership token for the particular digital media content item stored as part of the Seller's hold account. In other words, the copy of the ownership token is removed from storage in association with the Seller's wallet address. In effect, this forbids or denies the Seller rightful access to delivery and subsequent use of the particular digital media content item from the CDN nodes 130. Furthermore, the online wallet system 120 (or other data store operated by the service provider) can store a copy of the ownership token for the particular digital media content item associated with the Buyer's wallet address.

Furthermore, the copy of the ownership token as stored and associated with the Buyer's wallet address can be checked to give the Buyer rightful access to delivery of the particular digital media content item from the CDN nodes 130. Specifically, the ownership token can be required to request delivery (or perfect delivery) of the particular digital media content item from the CDN nodes 130 and unlock the DRM security features of the particular digital media content item as delivered from the CDN nodes 130.

In another embodiment, data representing a user's ownership token that has been offered or otherwise designated by the user (Seller) for resale, and possibly data representing the associated Seller's commission, can be stored on behalf of the Seller as part of a service-controlled “hold” account. The service-controller “hold” account is configured to hold data pertaining to the ownership token(s) of one or more Sellers that have been offered or otherwise designated for resale by the Seller(s). The service-controlled “hold” account can be maintained by the online wallet system 120 or possibly in some other data store maintained by the service provider. Note that any message that transfers an ownership token held in the service-controlled hold account to another user via a Resale contract requires a signature based on the private key of a participant seller (such as the service provider entity or administrator or publisher of the particular content item). The private key of the participant seller can be maintained by the online wallet system 120 or possibly in some other data store maintained by the service provider such that it is available when needed. The service-controlled “hold” account is a form of escrow account where the ownership token is held by the participant seller for the benefit of the appropriate Seller. The service-controlled “hold” account is designed to minimize any delay in transferring the ownership token held by the Seller to another user via resale, where such delay might occur because the Seller is unavailable and thus cannot provide input that is required to generate an appropriate signature derived from the Seller's private key.

Note that multiple users might possibly have offered for resale an ownership token for the same digital media content item. In this case, data representing such ownership tokens and possibly the data representing the corresponding Sellers' commissions can be stored in the service-controlled “hold” account and processed (which can possibly involve ranking the Sellers and corresponding ownership tokens based on the lowest Seller's commission) to select one of the available ownership tokens to be resold to a Buyer of the corresponding digital media content item. Other mechanisms, such as barter or auction or exchange services, can also be used to match the Buyer (via the Buyer's wallet address) to the Seller (via the Seller's wallet address).

In this embodiment, the purchase action of the Buyer can trigger the generation of a Resale message specific to the particular digital media content item (e.g., a Resale transaction or call to a Resale contract specific to the particular digital media content item). The Resale message can include one or more of the following data: the Buyer's wallet address, a signature derived from the private key of the Buyer, a wallet address of the participant seller, and a signature derived from the private key of the participant seller. The Buyer's wallet address identifies the intended recipient of the ownership token for the particular digital media content item. The signature derived from the private key of the Buyer can be verified against the Buyer's wallet address (public key) to verify that the Buyer has authorized the Resale message and its actions, particularly the transfer of cryptocurrency or other form of payment from the Buyer. The signature derived from the private key of the participant seller can be verified against the participant seller's wallet address (public key) to verify that the participant seller has authorized the Resale message and its actions, particularly the transfer of such ownership token from the Seller (via the service-controlled hold account) to the Buyer (via the Buyer's wallet address). The Resale message can also specify other data items for input to the Resale contract, such as the Seller's commission, the purchase price for the Seller's ownership token, and the percentage of the purchase price to transfer to various participants (such as the service provider and publisher of the particular digital media content item). The Resale message is transmitted and propagated across the ledger nodes 160. The Resale message invokes the terms of the Resale contract specific to the particular digital media content item, which when executed transfers the ownership token for the particular digital media content item from the Seller (via the service-controlled hold account) to the Buyer (via the Buyer's wallet address). When the ownership token is held by the Buyer by association with the Buyer's wallet address, the ownership token grants only the Buyer (through the Buyer's wallet address) permission to access the associated digital media content item unless such ownership token is transferred from the Buyer to another user by the invocation of a follow-on Resale contract.

The execution of the Resale contract can also transfer cryptocurrency (e.g., IRON) or other form of payment from the Buyer's wallet based on the purchase price of the ownership token and can also transfer cryptocurrency (e.g., IRON) or other form of payment to various participants based on the purchase price of the ownership token. For example, the purchase price of the ownership token in cryptocurrency or other form of payment can be transferred from the Buyer's wallet address, a part (e.g. 5%) of the purchase price of the ownership token in cryptocurrency or other form of payment can be transferred to a wallet address for the service provider, another part (e.g., 70%) of the purchase price of the ownership token in cryptocurrency or other form of payment can transferred to a wallet address for the publisher of particular digital media content item, and the Seller's commission can be transferred to the Seller's wallet address. In this manner, the execution of the Resale contract can split the purchase price for the ownership token in the cryptocurrency (e.g., IRON) or other form of payment between the service provider, the publisher of particular digital media content item, and the Seller.

Note that in some instances where the Seller's commission is less than an allowed maximum Seller's commission (for example, less than 25% of the purchase price for an ownership token for the particular digital media content item), the effective price that the Buyer pays for the ownership token can be reduced by the difference between the Seller's commission and the allowed maximum Seller's commission.

In other embodiments, one or more data items that are input to the Resale contract can be provided by an oracle that acts as a third-party data feed during execution of the Resale contract. Such data items can include the full purchase price for an ownership token for the particular digital media content item and the percentage of the full purchase price to transfer to various participants (such as the service provider and publisher of the particular digital media content item). Such data items can be stored in the digital ledger (or possibly in some other data store) and accessed by the oracle during execution of the Resale contract. It is contemplated that these data items might change over time with respect to a particular digital media content item as deemed appropriate by the publisher and/or service provider.

In this embodiment, each ledger node 160 that receives the Resale message can add the Resale message to its pool of pending messages. A miner node (which is one of the ledger nodes 160) can select a number of pending messages from its pool (which can include the Resale message) and validate the selected messages. The miner node can execute the contracts that are referenced or called by the valid selected messages (including the execution of the Resale contract when selected). The results from the above executions will change the balances of accounts and the data stored with the Resale contract (including the generation of new contract code). The validated messages and updated data are packaged into a block and a proof of work algorithm or puzzle is applied to the block. If the proof of work algorithm or puzzle is solved by the mining node, the mining node broadcasts this new block across the ledger nodes 160 of the network. Multiple miner nodes can compete against one another to solve for a new block and broadcast the new block across the ledger nodes 160 of the network.

Each ledger node 160 receiving this broadcasted new block can validate the new block and execute the contracts that are referenced or called by the messages of the new block (including the execution of the Resale contract) in the order specified by the new block, and record the resulting changes. Each ledger node 160 can verify that the new block as valid and if so, add the data for the new block to its copy of the distributed ledger.

Note that a reward of cryptocurrency (e.g., IRON) can be given to the operator of the mining node that is first to form a new valid block, which can be enforced through consensus of the ledger nodes 160 in validating the new blocks broadcast by the miner nodes.

In alternate embodiments, a mining node can be selected to form or mine the new block in a deterministic way depending on its wealth or stake. This is referred to as proof-of-stake mining. In this case, there is typically no reward for mining the new block, but the mining node receives transaction fees.

With the Resale message (and the execution results of the corresponding Resale contract) stored as part of the state of the distributed ledger, the online wallet system 120 can remove the copy of the ownership token for the particular digital media content item stored as part of the service-controlled hold account. In other words, the copy of the ownership token is removed from storage in association with the Seller's wallet address. In effect, this forbids or denies the Seller rightful access to delivery and subsequent use of the particular digital media content item from the CDN nodes 130. Furthermore, the online wallet system 120 (or other data store operated by the service provider) can store a copy of the ownership token for the particular digital media content item associated with the Buyer's wallet address.

Furthermore, the copy of the ownership token as stored and associated with the Buyer's wallet address can be checked to give the Buyer rightful access to delivery of the particular digital media content item from the CDN nodes 130. Specifically, the ownership token can be required to request delivery (or perfect delivery) of the particular digital media content item from the CDN nodes 130 and unlock the DRM security features of the particular digital media content item as delivered from the CDN nodes 130.

In embodiments, both the Purchase contract and the Resale contract as described above can be subcontracts of a Master contract. The Master contract can embody functions or other programming constructs that manage the creation, transfer and elimination (burning) of ownership tokens that are part of the Purchase contract and the Resale contract as described herein.

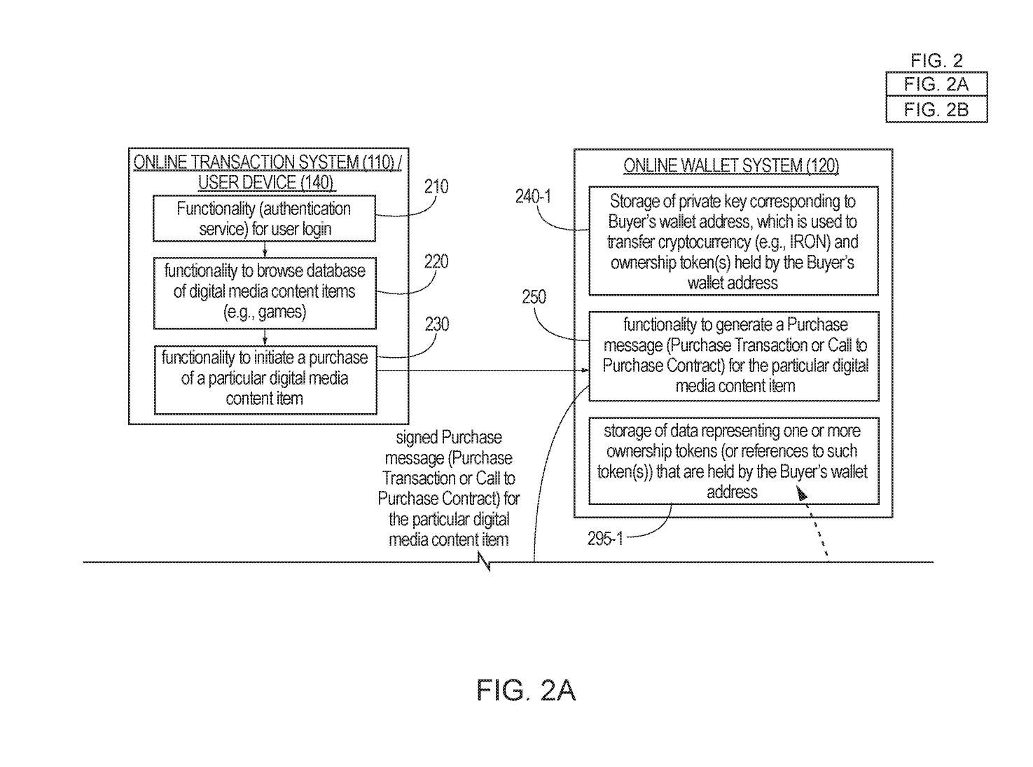

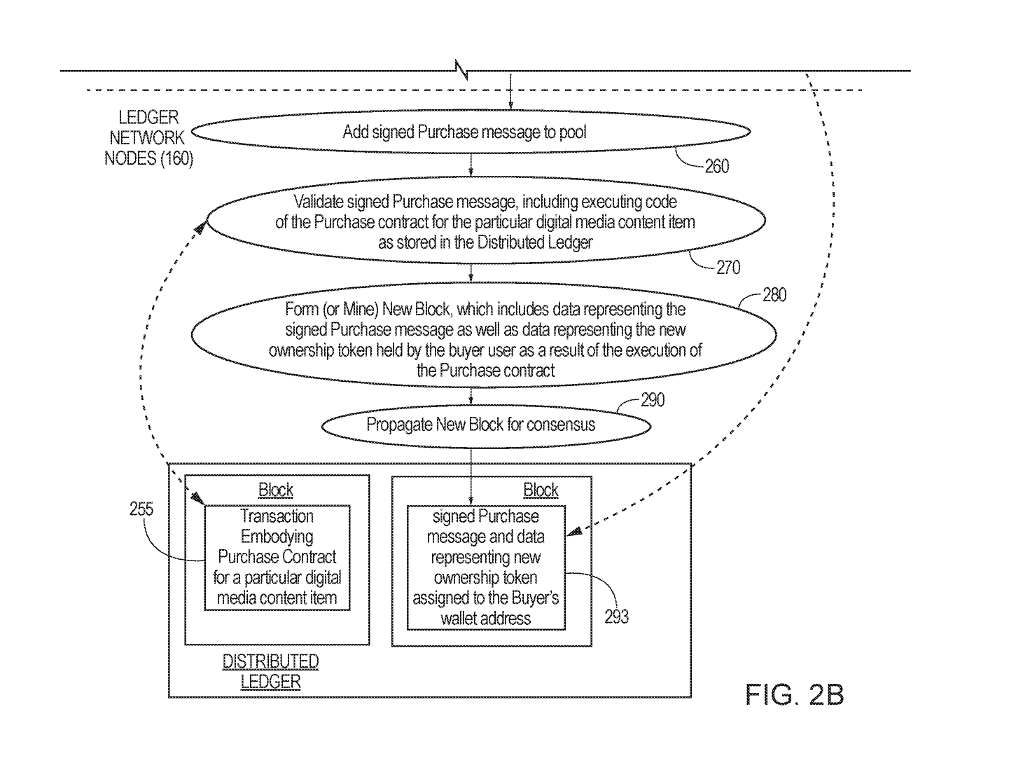

FIG. 2 illustrates one embodiment of a purchase process where a user (Buyer) acquires an ownership token for a particular digital media content item.

In block 210, the online transaction system 110 and the user device 140 can employ functionality (e.g., an authentication service) for user login to authenticate a user and allow access to the online transaction system 110.

In block 220, the online transaction system 110 and the user device 140 can employ functionality that allows the authenticated user to browse a database of digital media content items (e.g., online games).

In block 230, the online transaction system 110 and the user device 140 can employ functionality that allows the authenticated user (the Buyer) to initiate a purchase of a particular digital content item, which triggers the functionality of block 250 of the online wallet system 120.

In embodiments, the functionality of blocks 210, 220 and 230 can be embodied by a client-server model where the online transaction system 110 acts as a server and the user device 140 acts as a client whereby the server online transaction system provides the necessary services as requested by the client user device.

In block 240-1, the online wallet system 120 is configured to store a private key-public key pair corresponding to the Buyer's wallet address. Alternatively, the Buyer can store the private key in a hardware wallet or other form of storage. The online wallet system 120 can be configured to store the private key-public key pair corresponding to each respective user's wallet address. Alternatively, one or more of the respective users can store the private key in a hardware wallet or other form of storage. The private key of the user can be used to generate digital signatures for messages (such as the Purchase message and Resale message as described herein) that transfer cryptocurrency (e.g., IRON) or other form of payment and ownership tokens held by association with a respective user's wallet address. The digital signature of a message sent from a user's wallet address can be processed to verify that the digital signature matches the user's wallet address, which authenticates that the message was in fact sent from the user's wallet address and signed using the private key of the user.

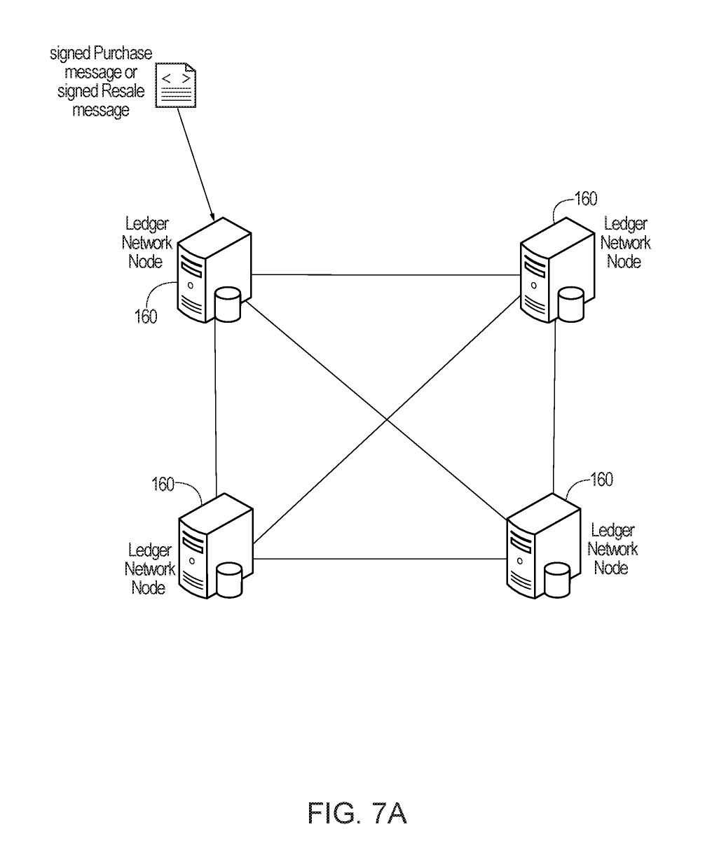

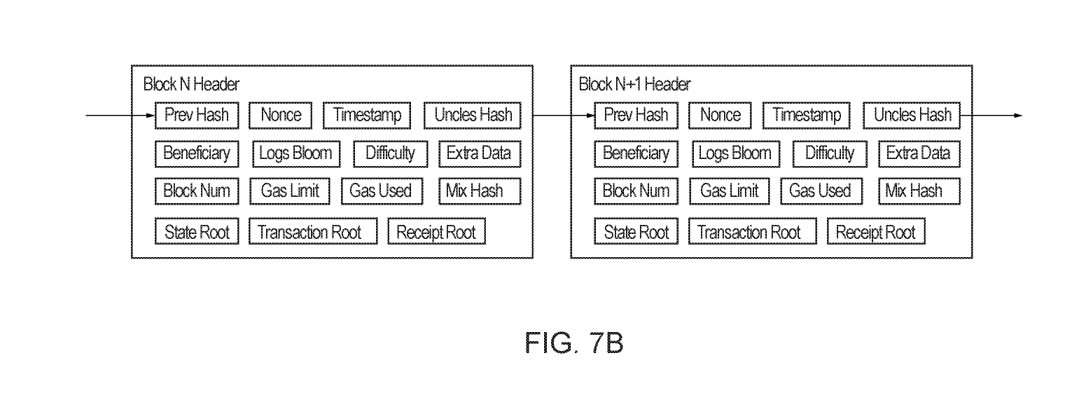

In block 250, the online wallet system 120 is configured to generate a Purchase message for the particular digital content item selected by the Buyer in block 230. The Purchase message includes one or more of the following data: the Buyer's wallet address, a signature (e.g., Buyer's signature) derived from the private key corresponding to the Buyer's wallet address, the address of a participant seller that is selling the ownership token (which can be the service provider or the publisher of the particular digital media content item), and a signature derived from the private key of the participant seller. The Buyer's wallet address identifies the intended recipient of the ownership token for the particular digital media content item. The Buyer's signature can be verified against the Buyer's wallet address (public key) to verify that the Buyer has authorized the Purchase message and its actions, particularly the transfer of cryptocurrency or other form of payment from the Buyer. The signature derived from the private key of the participant seller can be verified against the participant seller's wallet address (public key) to verify that the participant seller has authorized the Purchase message and its actions, particularly the creation of the ownership token for the particular digital media content item and the transfer of such ownership token to the Buyer (via the Buyer's wallet address). The Buyer's signature can be generated by the online wallet system 120 based on the Buyer's private key stored by the online wallet system 120 (block 240-1) or provided by the Buyer. Alternatively, the Buyer's signature can be generated by the Buyer's hardware wallet based on the Buyer's private key stored by the hardware wallet, and the Buyer's signature can be communicated to the online wallet system 120. The signature of the participant seller can be generated by the online wallet system 120 based on the private key of the participant seller stored by the online wallet system 120 or provided by some other data source. The signed Purchase message is sent to a ledger node 160 for propagation the ledger nodes 160 of the network (FIG. 7A).

The signed Purchase message can also include one or more additional data items, such as:
a reference or identifier to the particular digital content item;
a reference (such as an address) to the Purchase contract for the particular digital content item stored in the distributed ledger (block 255);
the purchase price for ownership token, which is a value of cryptocurrency (e.g., IRON) or other form of payment to be transferred from the Buyer's wallet address; and
the percentage of the purchase price to transfer to various participants (such as the service provider and publisher of the particular digital media content item).

The signed Purchase message can invoke the execution of the Purchase contract for the particular digital content item that is referenced by the signed Purchase message and stored in the distributed ledger (block 255). The terms of the Purchase contract can be specific to the particular media content item and can be invoked by many signed Purchase messages that are propagated by the network of ledger nodes 160 and stored as part of the state of the distributed ledger as described herein. Some of the terms of the Purchase contract can be based on data items input by the signed Purchase message or by operations of an oracle during execution of the Purchase contract as described herein. The Purchase contract for the particular digital content item can be embodied by one or more method(s) (e.g., bytecode sequence(s)). In embodiments, such method(s) can involve a number of operations when executed as follows:
generating an ownership token for the particular digital content item and transferring or assigning the ownership token for the particular digital content item to the Buyer's wallet address;
transferring the purchase price for the ownership token in cryptocurrency (e.g., IRON) or other form of payment from the Buyer's wallet address;
transferring the purchase price for the ownership token in cryptocurrency (e.g., IRON) or other form of payment to the address of one or more wallets and ensuring that predetermined percentages are distributed to the proper wallet addresses; for example, one part (e.g., 5%) can be transferred to the wallet address of the service provider, and another part (e.g., 95%) can be transferred to the wallet address of the publisher of the particular digital content item; and
possibly transferring applicable fees (e.g., gas in IRON) from the wallet address of the Buyer to the wallet address of the node operator that processes the Purchase message and executes the Purchase contract.

In other embodiments, one or more data items that are input to the Purchase contract can be provided by an oracle that acts as a third-party data feed during execution of the Purchase contract. Such data items can include the full purchase price for an ownership token in cryptocurrency (e.g., IRON) for the particular digital media content item and the percentage of the full purchase price to transfer to various participants (such as the service provider and publisher of the particular digital media content item). Such data items can be stored in the digital ledger (or possibly in some other data store) and accessed by the oracle during execution of the Purchase contract. It is contemplated that these data items might change over time with respect to a particular digital media content item as deemed appropriate by the publisher and/or service provider.

In embodiments, the signed Purchase message can include data fields corresponding to Ethereum transactions, including:
Nonce, which is the transaction sequence number for the sending user's address (e.g., the Buyer's wallet address);
Gas price, which is the price of gas the sending user is offering to pay;
Start gas, which is the maximum amount of gas allowed for the transaction;
To, which is the destination address of the message (either an account address or contract address);
Value, which is the amount of cryptocurrency (e.g., IRON) to transfer to the destination address, if any;
Data for the transaction, which can encode raw data or a contract function signature and parameters; and
v/r/s, which are components of the ECDSA signature of the sending user (e.g., the Buyer's signature).

Note that the data fields can be RLP-encoded in the order shown. Also note that the field names are not part of the encoded data fields.

In embodiments, the method(s) of the Purchase contract for the particular digital content item as stored in the distributed ledger (block 255) can be invoked by sending a signed Purchase message (e.g., Purchase transaction or a Call to the Purchase contract) to the address assigned to the Purchase contract. These mechanisms are similar to the mechanisms for invoking smart contracts in the Ethereum protocol. In particular, the Purchase contract can be previously compiled and stored on the distributed ledger at an assigned address. The Purchase contract can be invoked by sending the signed Purchase transaction to the address assigned to the Purchase contract or by calling the address assigned to the Purchase contract and passing one or more parameters and optionally, indicating one or more methods or subfunctions within the Purchase contract. Examples of parameters may include, but are not limited or restricted to, contact information of the Buyer (name, address, city, state, zip) and the Buyer's wallet address.

When the account balance of the Buyer's wallet address does not contain sufficient cryptocurrency (e.g., IRON) or other form of payment to purchase the ownership token for the particular digital media content item, the platform may provide a suggestion, e.g., via a pop-up screen, that the user convert other cryptocurrency or fiat into the cryptocurrency (e.g., IRON) of the platform 100.

Data can be stored and retrieved from the Purchase contract via an Application Binary Interface (ABI). The ABI will also determine implementation details such as how methods of functions are called and in which binary format information should be passed from one program component to the next. The ABI can be used to ensure that specific desired contract function can be invoked while ensuring that the function will return data in the format expected.

In embodiments, the Purchase contract can possibly include the ability to transfer cryptocurrency (e.g., IRON) to investors, management, etc. (optionally along with selling locks to ensure the cryptocurrency is not sold within a predetermined amount of time); transfer cryptocurrency (e.g., IRON) to buyers and sellers; provide refunds by transferring cryptocurrency (e.g., IRON) to the wallet address of a buyer, or other party requesting the refund; and burn cryptocurrency by sending cryptocurrency to an invalid address.

In block 260, each ledger node 160 that receives the signed Purchase message adds the signed Purchase message to its pool (or queue) of pending messages (transactions and contract calls).

In block 270, a mining node (which belongs to the one or more ledger nodes 160) selects a number of messages from the pool (which can include the signed Purchase message) and validates the selected messages. The validation of the Purchase message can include or trigger executing code of the Purchase contract for the particular digital media content item as stored in the distributed ledger. Such validation can also include additional operations, such as one or more of the following:

verifying that the balance of available cryptocurrency or other form of payment of the Buyer's wallet address (e.g., sending user's address) is equal to or exceeds the value of cryptocurrency or other form of payment transferred from the Buyer's wallet address by the Purchase message;

verifying that the signature of the Buyer corresponds to the Buyer's wallet address (which is derived from the Buyer's public key);

verifying that the signature of the participant seller corresponds to the participant seller's wallet address (which is derived from the participant seller's public key); and

verifying other necessary conditions or rules. In this embodiment, the verification of the signature of the participant seller can provide for effective electronic authorization by the participant seller of the issuance of the ownership token to the Buyer. The verification of the signature of the Buyer can provide for effective electronic authorization by the Buyer of the transfer of cryptocurrency or other form of payment for the ownership token from the Buyer to the various participants. The execution of the purchase contract can create the digital token associated with the particular digital media content item, assign such digital token to the Buyer, transfer the purchase price for the ownership token to various participants, and possibly perform other actions as described herein.

In other embodiments, the signature of the participant seller can be omitted from the Purchase message, and the validation operations can omit verifying that the signature of the participant seller corresponds to the participant seller's wallet address. In this embodiment, the validation of the purchase message can provide for effective electronic authorization by the service provider entity (or service administrator or publisher entity) of the issuance of the digital token to the Buyer. The verification of the signature of the Buyer can provide for effective electronic authorization by the Buyer of the transfer of cryptocurrency or other form of payment for the ownership token from the Buyer to the various participants. The execution of the purchase contract can create the digital token associated with the particular digital media content item, assign such digital token to the Buyer, transfer the purchase price for the ownership token to various participants, and possibly perform other actions as described herein.

In block 280, the mining node forms (or mine) a new block, which includes data representing the signed Purchase transaction (or call to the Purchase contract) as well as data representing the ownership token held by the buyer user as a result of the execution of the Purchase contract.

In block 290, the mining node propagates the new block to the ledger nodes 160 of the network for consensus. In order to achieve consensus, each ledger node 160 receiving the broadcasted new block can execute the transactions (including the execution of the Purchase contract) in the order specified by the new block, and record the resulting changes. Each ledger node 160 can verify that the new block as valid and if so, add the data for the new block to its copy of the distributed ledger (block 293). The validation of the new block can involve validating each message that is part of the block in a manner similar to the validation of the Purchase message as described above.

With the Purchase message (and execution results of the corresponding Purchase contract) stored as part of the state of the distributed ledger (block 293), the online wallet system 120 (or possibly some other data store maintained by the service provider) can store a copy of the ownership token for the particular digital media content item (which results from the execution of the corresponding Purchase contract) as part of the Buyer's wallet account (block 295-1). In other words, the copy of the ownership token can be stored and associated with the Buyer's wallet address.

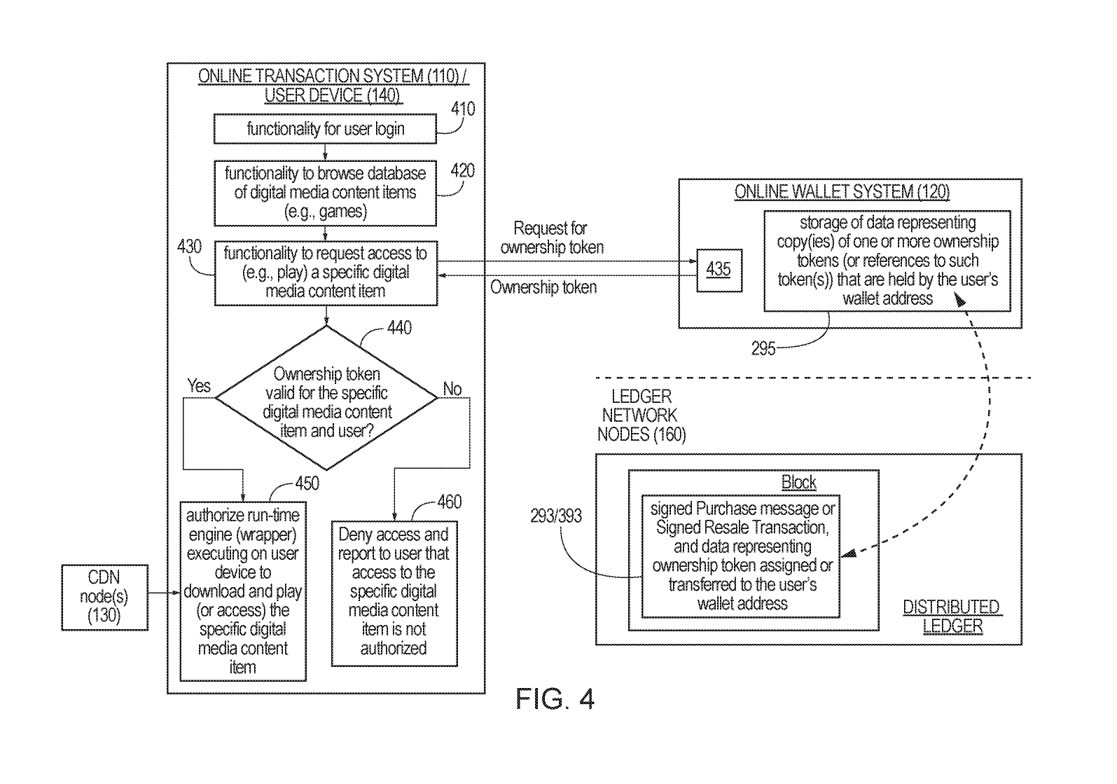

Furthermore, the copy of the ownership token stored and associated with the Buyer (via the Buyer's wallet address) can be checked to give the Buyer rightful access to delivery of the particular digital media content item from the CDN nodes 130. Specifically, the ownership token can be required to request delivery (or perfect delivery) of the particular digital media content item from the CDN nodes 130 and unlock the DRM security features of the particular digital media content item as delivered from the CDN nodes 130 (FIG. 4).

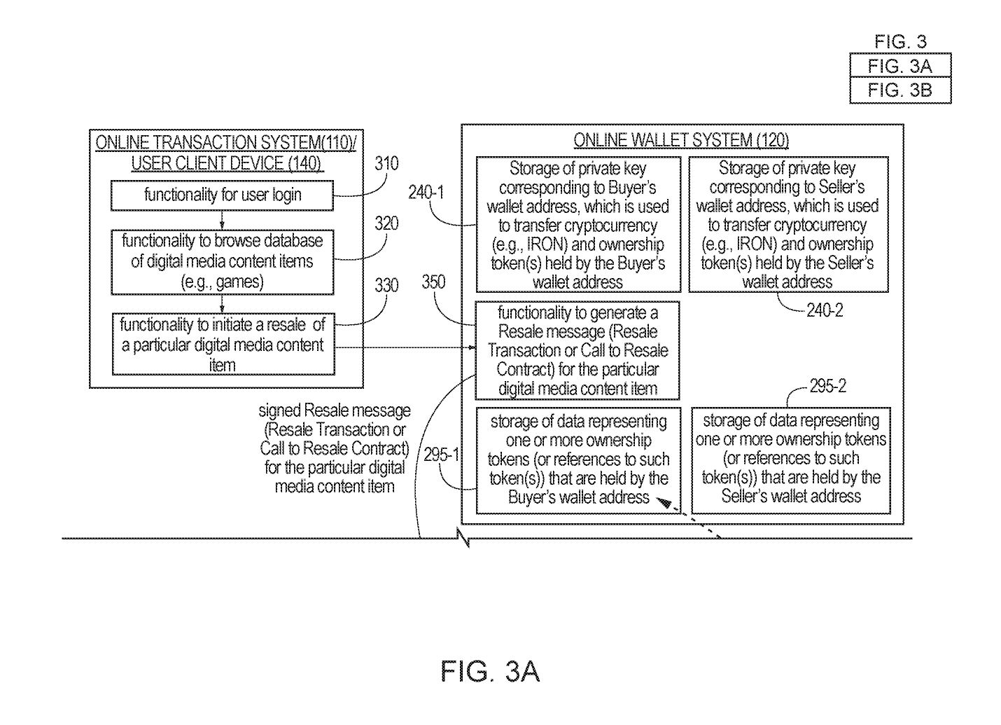

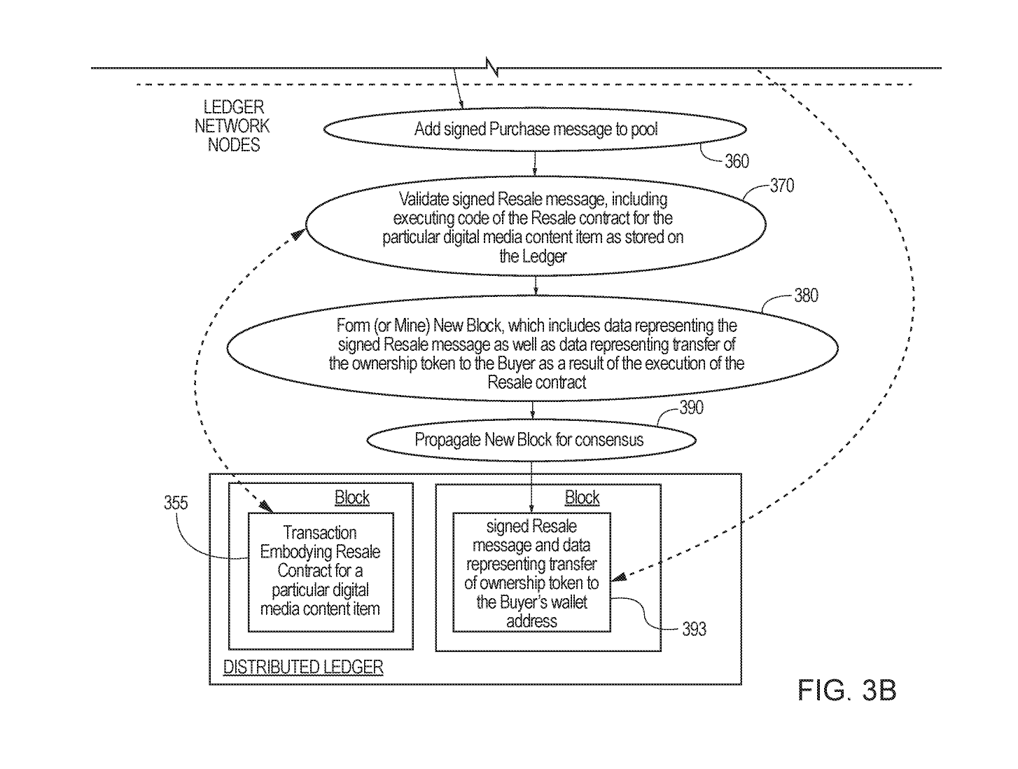

FIG. 3 illustrates one embodiment of a resale process where the ownership token for a particular digital media content item is transferred from a user that has offered the ownership token for resale (Seller) to another user (Buyer). In this embodiment, data representing a user's ownership token that has been offered or otherwise designated by the Seller for resale, and possibly data representing the associated Seller's commission, can be stored as part of the Seller's wallet account or possibly in some other data store maintained by the service provider (block 295-2). Furthermore, any message that transfers the ownership token held by the Seller to another user via a Resale contract can require a signature based on the private key of the Seller.

In block 310, the online transaction system 110 and the user device 140 can employ functionality (e.g., an authentication service) for user login to authenticate a user and allow access to the online transaction system 110.

In block 320, the online transaction system 110 and the user device 140 can employ functionality that allows the authenticated user to browse a database of digital media content items (e.g., online games).

In block 330, the online transaction system 110 and the user device 140 can employ functionality that allows the authenticated user (Buyer) to initiate a purchase of a particular digital content item, which triggers the functionality of block 350 of the online wallet system 120.

In embodiments, the functionality of blocks 310, 320 and 330 can be embodied by a client-server model where the online transaction system 110 acts as a server and the user device 140 acts as a client whereby the server online transaction system provides the necessary services as requested by the client user device.

In block 240-1, the online wallet system 120 is configured to store a private key-public key pair corresponding to the Buyer's wallet address. Alternatively, the Buyer can store the private key in a hardware wallet or other form of storage. In block 240-2, the online wallet system 120 is configured to store the private key-public key pair corresponding to the Seller's wallet address. Alternatively, the Seller can store the private key in a hardware wallet or other form of storage. The online wallet system 120 can be configured to store the private key-public key pair corresponding to each respective user's wallet address. Alternatively, one or more of the respective users can store the private key in a hardware wallet or other form of storage. The private key of the user can be used to generate digital signatures for messages (such as the Purchase message and Resale message as described herein) that transfer cryptocurrency (e.g., IRON) or other form of payment and ownership tokens held by association with a respective user's wallet address. The digital signature of a message sent from a user's wallet address can be processed to verify that the digital signature matches the user's wallet address, which authenticates that the message was in fact sent from the user's wallet address and signed using the private key of the user.

In block 350, the online wallet system 120 is configured to generate a Resale message for the particular digital content item selected by the Buyer in block 330. The Resale message can include one or more of the following data: the Buyer's wallet address, a signature (e.g., Buyer's signature) derived from the private key corresponding to the Buyer's wallet address, the Seller's wallet address, and a signature (e.g., Seller's signature) derived from the private key corresponding to the Seller's wallet address. The Buyer's wallet address identifies the intended recipient of the ownership token for the particular digital media content item. The Buyer's signature can be verified against the Buyer's wallet address (public key) to verify that the Buyer has authorized the Resale message and its actions, particularly the transfer of cryptocurrency or other form of payment from the Buyer. The Seller's signature can be verified against the Seller's wallet address (public key) to verify that the Seller has authorized the Resale message and its actions, particularly the transfer of such ownership token from the Seller (via the Seller's wallet address) to the Buyer (via the Buyer's wallet address). The Buyer's signature can be generated by the online wallet system 120 based on the Buyer's private key stored by the online wallet system 120 (block 240-1) or provided by the Buyer. Alternatively, the Buyer's signature can be generated by the Buyer's hardware wallet based on the Buyer's private key stored by the hardware wallet, and the Buyer's signature can be communicated to the online wallet system 120. The Seller's signature can be generated by the online wallet system 120 based on the Seller's private key stored by the online wallet system 120 (block 240-2) or provided by the Seller. Alternatively, the Seller's signature can be generated by the Seller's hardware wallet based on the Seller's private key stored by the hardware wallet, and the Seller's signature can be communicated to the online wallet system 120. The signed Resale message is sent to a ledger node 160 for propagation the ledger nodes 160 of the network (FIG. 7A).

The signed Resale message can also include one or more additional data items, such as:
a reference or identifier to the particular digital content item;
a reference (such as an address) to the Resale contract for the particular digital content item stored in the distributed ledger (block 355);
a value of cryptocurrency (e.g., IRON) or other form of payment to be transferred from the Buyer's wallet address to acquire the ownership token;
the purchase price for the ownership token (which need not be the same as the value of cryptocurrency (e.g., IRON) or other form of payment to be transferred from the Buyer's wallet address);
the Seller's commission; and
the percentage of the purchase price to transfer to various participants (such as the service provider and publisher of the particular digital media content item).

The signed Resale message can invoke the execution of the Resale contract for the particular digital content item that is referenced by the signed Purchase message and stored in the distributed ledger (block 355). The terms of the Resale contract can be specific to the particular media content item and can be invoked by many signed Resale messages that are propagated by the network of ledger nodes 160 and stored as part of the state of the distributed ledger as described herein. Some of the terms of the Resale contract can be based on data items input by the signed Resale message or by operations of an oracle during execution of the Resale contract as described herein. The Resale contract for the particular digital content item can be embodied by one or more method(s) (e.g., bytecode sequence(s)). In embodiments, such method(s) can involve a number of operations when executed as follows:

verifying that the Seller's wallet address currently holds an ownership token for the particular digital content item;

transferring the ownership token for the particular digital content item to the Buyer's wallet address;

transferring the value of cryptocurrency (e.g., IRON) or other form of payment that is specified to acquire the ownership token from the Buyer's wallet address;

transferring the Seller's commission in cryptocurrency (e.g., IRON) or other form of payment to the Seller's wallet address; for example, this can transfer up to 20% of the price in cryptocurrency (e.g., IRON) for the ownership token to the Seller's wallet address;

transferring part of the purchase price of the ownership token in cryptocurrency (e.g., IRON) or other form of payment to the address of one or more wallets; for example, part (e.g., 5%) of the purchase price in cryptocurrency (e.g., IRON) or other form of payment can be transferred to the wallet address of the service provider, and another part (e.g., 75%) of the purchase price in cryptocurrency (e.g., IRON) or other form of payment can be transferred to the wallet address of the publisher of the particular digital content item; and

possibly transferring applicable fees (e.g., gas in IRON) from the Buyer's wallet address to the wallet address of the node operator that processes the Purchase message and executes the Purchase contract.

In embodiments, the signed Resale message can include data fields corresponding to Ethereum transactions, including:
Nonce, which is the transaction sequence number for the sending user's address (e.g., the Buyer's wallet address);
Gas price, which is the price of gas the sending user is offering to pay;
Start gas, which is the maximum amount of gas allowed for the transaction;
To, which is the destination address of the message (either an account address or contract address);
Value, which is the amount of cryptocurrency (e.g., IRON) to transfer to the destination address, if any;
Data for the transaction, which can encode raw data or a contract function signature and parameters; and
v/r/s, which are components of the ECDSA signature of the sending user (e.g., the Buyer's signature).

Note that the data fields can be RLP-encoded in the order shown. Also note that the field names are not part of the encoded data fields.

In embodiments, the method(s) of the Resale contract for the particular digital content item as stored in the distributed ledger (block 355) can be invoked by sending a signed Resale message (e.g., Resale transaction or a Call to the Resale contract) to the address assigned to the Resale contract. These mechanisms are similar to the mechanisms for invoking smart contracts in the Ethereum protocol. In particular, the Resale contract can be previously compiled and stored on the distributed ledger at an assigned address. The Resale contract can be invoked by sending the signed Resale transaction to the address assigned to the Resale contract or by calling the address assigned to the Resale contract and passing one or more parameters and optionally, indicating one or more methods or subfunctions within the Resale contract. Examples of parameters may include, but are not limited or restricted to, contact information of the Buyer (name, address, city, state, zip), the Buyer's wallet address, contact information of the Seller (name, address, city, state, zip), and the Buyer's wallet address.

When the account balance of the Buyer's wallet address does not contain sufficient cryptocurrency (e.g., IRON) or other form of payment to purchase the ownership token for the particular digital media content item, the platform may provide a suggestion, e.g., via a pop-up screen, that the user convert other cryptocurrency or fiat into the cryptocurrency (e.g., IRON) of the platform 100.

Data can be stored and retrieved from the Resale contract via an Application Binary Interface (ABI). The ABI will also determine implementation details such as how methods of functions are called and in which binary format information should be passed from one program component to the next. The ABI can be used to ensure that specific desired contract function can be invoked while ensuring that the function will return data in the format expected.

In embodiments, the Resale contract can possibly include the ability to transfer cryptocurrency (e.g., IRON) to investors, management, etc. (optionally along with selling locks to ensure the cryptocurrency is not sold within a predetermined amount of time); transfer cryptocurrency (e.g., IRON) to buyers and sellers; provide refunds by transferring cryptocurrency (e.g., IRON) to the wallet address of a buyer or other party requesting the refund; and burn cryptocurrency by sending cryptocurrency to an invalid address.

In block 360, each ledger node 160 that receives the signed Resale message adds the signed Resale message (Resale transaction or call to the Resale contract) to its pool (or queue) of pending messages.

In block 370, a miner node (which belongs to the one or more ledger nodes 160) selects a number of pending messages from its pool (which can include the Resale message) and validates the selected messages. The validation of the Resale message can involve or trigger the execution of the Resale contract for the particular digital media content item as stored in the distributed ledger. Such validation can also include additional operations, such as:

verifying that the balance of available cryptocurrency of the Buyer's wallet address (e.g., sending user's address) is equal to or exceeds the value of cryptocurrency transferred from the Buyer's wallet address by the Resale message;

verifying that the signature of the Buyer corresponds to the Buyer's wallet address (which is derived from the Buyer's public key);

verifying that the signature of the Seller corresponds to the Seller's wallet address (which is derived from the Seller's public key); and

verifying other necessary conditions or rules.

In this embodiment, the verification of the signature of the Seller can provide for effective electronic authorization by the Seller of the transfer of the digital token to the Buyer. The verification of the signature of the Buyer can provide for effective electronic authorization by the Buyer of the transfer of cryptocurrency or other form of payment for the ownership token from the Buyer to the various participants. The execution of the Resale contract can transfer such digital token to the Buyer, transfer the purchase price for the ownership token to various participants and possibly perform other actions as described herein.

In block 380, the mining node forms (or mine) a new block, which includes data representing the signed Resale message as well as data representing the ownership token held by the Buyer user as a result of the execution of the Resale contract.

In block 390, the mining node propagates the new block to the ledger nodes 160 of the network for consensus. In order to achieve consensus, each ledger node 160 receiving the broadcasted new block can execute the transactions (including the execution of the Resale contract) in the order specified by the new block, and record the resulting changes. Each ledger node 160 can verify that the new block as valid and if so, add the data for the new block to its copy of the distributed ledger (block 393). The validation of the new block can involve validating each message that is part of the block in a manner similar to the validation of the Resale message as described above.

With the Resale message (and the execution results of the corresponding Resale contract) stored as part of the state of the distributed ledger, the online wallet system 120 can remove the copy of the ownership token for the particular digital media content item stored as part of the Seller's wallet account (block 295-2). In other words, the copy of the ownership token is removed from storage by the online wallet system 120 in association with the Seller's wallet address. In effect, this forbids or denies the Seller rightful access to delivery and subsequent use of the particular digital media content item from the CDN nodes 130 (FIG. 4). Furthermore, the online wallet system 120 can store a copy of the ownership token for the particular digital media content item as part of the Buyer's wallet account (block 295-1). In other words, the copy of the ownership token can be stored by the online wallet system 120 and associated with the Buyer's wallet address.

Furthermore, the copy of the ownership token stored by the online wallet system 120 and associated with the Buyer's wallet address (block 295-1) can be checked to give the Buyer rightful access to delivery of the particular digital media content item from the CDN nodes 130. Specifically, the ownership token can be required to request delivery (or perfect delivery) of the particular digital media content item from the CDN nodes 130 and unlock the DRM security features of the particular digital media content item as delivered from the CDN nodes 130 (FIG. 4).

FIG. 4 illustrates one embodiment of a process where the ownership token for a specific digital media content item that is held by a user's address is checked to permit access to the specific digital media content item.

In block 410, the online transaction system 110 and the user device 140 can employ functionality (e.g., an authentication service) for user login to authenticate a user and allow access to the online transaction system 110.

In block 420, the online transaction system 110 and the user device 140 can employ functionality that allows the authenticated user to browse a database of digital media content items (e.g., online games).

In block 430, the online transaction system 110 and the user device 140 can employ functionality that allows the authenticated user to request access to (e.g., play) a specific digital media content item, which triggers a request to the functionality of block 435 of the online wallet system 120.

In embodiments, the functionality of blocks 410, 420 and 430 can be embodied by a client-server model where the online transaction system 110 acts as a server and the user device 140 acts as a client whereby the server online transaction system provides the necessary services as requested by the client user device.

In block 435, the online wallet system 120 checks its storage of data representing copy(ies) of one or more ownership tokens (or references to such token(s)) that are held by the user's wallet address (block 295). Such data is derived from the ownership tokens that are held by the user's wallet address, which are dictated by one or more corresponding Purchase messages (with execution of the Purchase contract), and/or or by a corresponding Resale messages (with execution of the Resale contract), and represented by the state of the distributed ledger as stored by one or more blocks of the distributed ledger (block 293 or 393). If the online wallet system 120 stores data representing a copy of an ownership token for the specific digital media content item (or a reference to such token(s)) that is held by the user's wallet address, the matching ownership token is returned to the online transaction system 110. Otherwise (when the online wallet system 120 does not store data representing a copy of an ownership token for the specific digital media content item (or a reference to such token(s)) that is held by the user's wallet address), the online wallet system 120 returns an empty or null value to the online transaction system 110.

In block 440, the online transaction system 110 processes the data returned online wallet system 120 to determine if such data is a valid ownership token copy. If so, the operations continue to block 450. If not, the operations continue to block 460.

In block 450, the online transaction system 110 authorizes a run-time engine (wrapper) executing on the client device 140 to download and play (or otherwise access) the specific digital content item from the CDN nodes 130. Specifically, the ownership token can be required to request delivery (or perfect delivery) of the specific digital media content item from the CDN nodes 130 and unlock the DRM security features of the specific digital media content item as delivered from the CDN nodes 130.

In block 460, the online transaction system 110 denies access to the specific digital media content item as stored in the CDN nodes 130 and can cooperate with the user device 140 to report to user that access to the specific digital content item is not authorized.

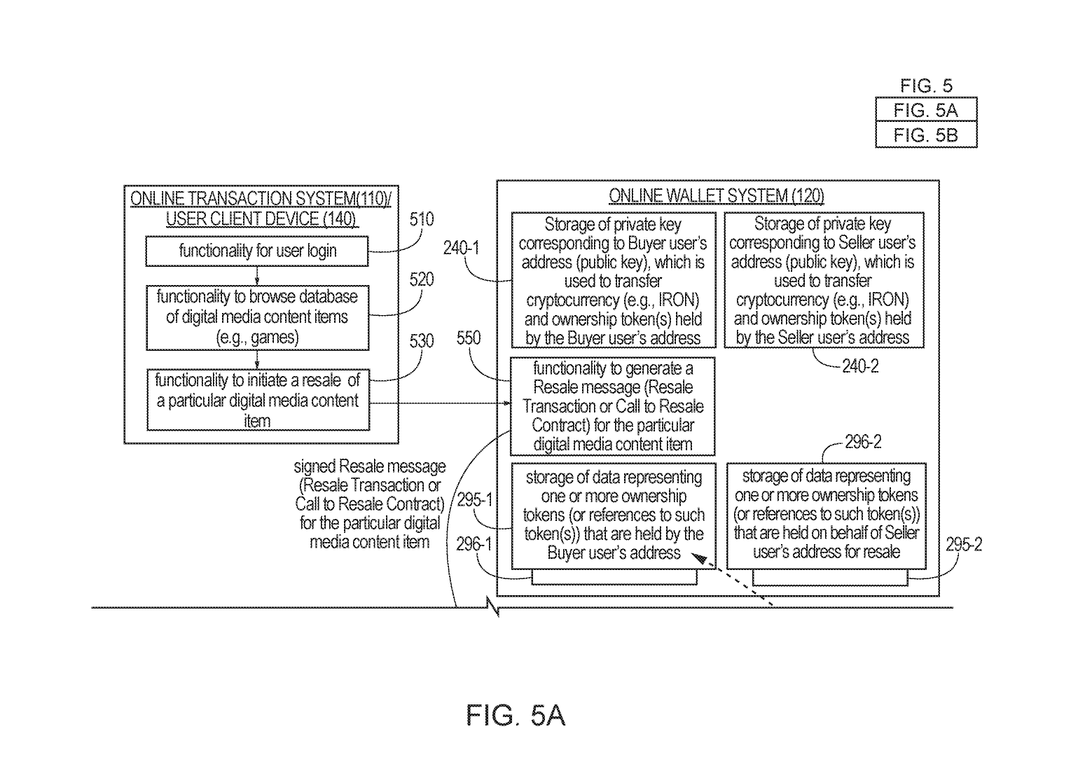

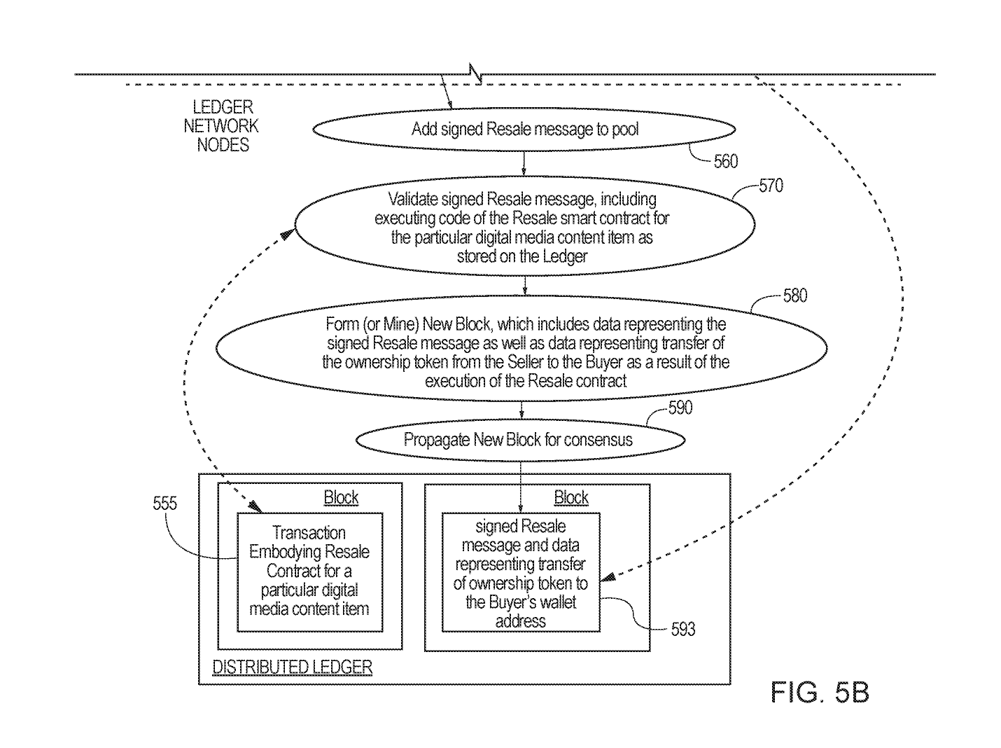

FIG. 5 illustrates another embodiment of a resale process where the ownership token for a particular digital media content item is transferred from a user that has offered the ownership token for resale (Seller) to another user (Buyer). In this embodiment, data representing the Seller's ownership token that has been offered or otherwise designated for resale, and possibly data representing the associated Seller's commission, can be stored on behalf of the Seller as part of a “hold” account for the Seller (block 296-2). The hold account for the Seller holds data pertaining to the ownership token(s) of the Seller that have been offered or otherwise designated for resale by the Seller. Once offered or otherwise designated for sale by the Seller, the ownership token is removed from the data representing the tokens held by the Seller (block 295-2) and added to the hold account for the Seller (block 296-2). The “hold” account for the Seller can be maintained by the online wallet system 120 or possibly in some other data store maintained by the service provider. Note that any message that transfers an ownership token held in the Seller's hold account to another user via a Resale Contract requires a signature based on the private key of a participant seller (such as the publisher of the particular content item or the service provider) that is authorized to do so by the Seller. The Seller can grant such authorization as part of terms of use consented to by the Seller. The private key of the participant seller can be maintained by the online wallet system 120 or possibly in some other data store maintained by the service provider such that it is available when needed. The Seller's “hold” account is a form of escrow account where the ownership token is held by the participant seller for the benefit of the Seller. The Seller's “hold” account is designed to minimize any delay in transferring the ownership token held by Seller to another user via resale, where such delay might occur because the Seller is unavailable and thus cannot provide input that is required to generate an appropriate signature derived from the Seller's private key.

In block 510, the online transaction system 110 and the user device 140 can employ functionality (e.g., an authentication service) for user login to authenticate a user and allow access to the online transaction system 110.

In block 520, the online transaction system 110 and the user device 140 can employ functionality that allows the authenticated user to browse a database of digital media content items (e.g., online games).

In block 530, the online transaction system 110 and the user device 140 can employ functionality that allows the authenticated user (Buyer) to initiate a purchase of a particular digital content item, which triggers the functionality of block 550 of the online wallet system 120.

In embodiments, the functionality of blocks 510, 520 and 530 can be embodied by a client-server model where the online transaction system 110 acts as a server and the user device 140 acts as a client whereby the server online transaction system provides the necessary services as requested by the client user device.

In block 240-1, the online wallet system 120 is configured to store a private key-public key pair corresponding to the Buyer's wallet address. Alternatively, the Buyer can store the private key in a hardware wallet or other form of storage. The online wallet system 120 is also configured to store the private key-public key pair corresponding to the participant seller's wallet address. The online wallet system 120 can be configured to store the private key-public key pair corresponding to each respective user's wallet address. Alternatively, one or more of the respective users can store the private key in a hardware wallet or other form of storage. The private key of the user can be used to generate digital signatures for messages (such as the Purchase message and Resale message as described herein) that transfer cryptocurrency (e.g., IRON) or other form of payment and ownership tokens held by a respective user's wallet address. The digital signature of a message sent from a user's wallet address can be processed to verify that the digital signature matches the user's wallet address, which authenticates that the message was in fact sent from the user's wallet address and signed using the private key of the user.

In block 550, the online wallet system 120 is configured to generate a Resale message for the particular digital content item selected by the Buyer in block 530. The Resale message can include one or more of the following data: the Buyer's wallet address, a signature (e.g., Buyer's signature) derived from the private key corresponding to the Buyer's wallet address, the Seller's wallet address, the participant seller's wallet address, and a signature derived from the private key corresponding to the participant seller's wallet address. The Buyer's wallet address identifies the intended recipient of the ownership token for the particular digital media content item. The Buyer's signature can be verified against the Buyer's wallet address (public key) to verify that the Buyer has authorized the Resale message and its actions, particularly the transfer of cryptocurrency or other form of payment from the Buyer. The signature derived from the private key corresponding to the participant seller's wallet address can be verified against the participant seller's wallet address (public key) to verify that the participant seller has authorized the Resale message and its actions, particularly the transfer of such ownership token from the Seller (via the Seller's hold account) to the Buyer (via the Buyer's wallet address). The Buyer's signature can be generated by the online wallet system 120 based on the Buyer's private key stored by the online wallet system 120 (block 240-1) or provided by the Buyer. Alternatively, the Buyer's signature can be generated by the Buyer's hardware wallet based on the Buyer's private key stored by the hardware wallet, and the Buyer's signature can be communicated to the online wallet system 120. The participant seller's signature can be generated by the online wallet system 120 based on the participant seller's private key stored by the online wallet system 120. The signed Resale message is sent to a ledger node 160 for propagation the ledger nodes 160 of the network (FIG. 7A).

The signed Resale message can also include one or more additional data items, such as:
a reference or identifier to the particular digital content item;
a reference (such as an address) to the Resale contract for the particular digital content item stored in the distributed ledger (block 555);
a value of cryptocurrency (e.g., IRON) or other form of payment to be transferred from the Buyer's wallet address to acquire the ownership token;
the purchase price for the ownership token (which need not be the same as the value of cryptocurrency (e.g., IRON) or other form of payment to be transferred from the Buyer's wallet address);
the Seller's commission; and
the percentage of the purchase price to transfer to various participants (such as the service provider and publisher of the particular digital media content item).

The signed Resale message can invoke the execution of the Resale contract for the particular digital content item that is referenced by the signed Purchase message and stored in the distributed ledger (block 555). The terms of the Resale contract can be specific to the particular media content item and can be invoked by many signed Resale messages that are propagated by the network of ledger nodes 160 and stored as part of the state of the distributed ledger as described herein. Some of the terms of the Resale contract can be based on data items input by the signed Resale message or by operations of an oracle during execution of the Resale contract as described herein.

The Resale contract for the particular digital content item can be embodied by one or more method(s) (e.g., bytecode sequence(s)). In embodiments, such method(s) can involve a number of operations when executed as follows:

verifying that the Seller's wallet address currently holds an ownership token for the particular digital content item;

transferring the ownership token for the particular digital content item to the Buyer's wallet address;

transferring the value of cryptocurrency (e.g., IRON) or other form of payment that is specified to acquire the ownership token from the Buyer's wallet address;

transferring the Seller's commission in cryptocurrency (e.g., IRON) to the Seller's wallet address; for example, this can transfer up to 20% of the price in cryptocurrency (e.g., IRON) for the ownership token to the Seller's wallet address;

transferring part of the purchase price of the ownership token in cryptocurrency (e.g., IRON) or other form of payment to the address of one or more wallets; for example, part (e.g., 5%) of the purchase price in cryptocurrency (e.g., IRON) or other form of payment can be transferred to the wallet address of the service provider, and another part (e.g., 75%) of the purchase price in cryptocurrency (e.g., IRON) or other form of payment can be transferred to the wallet address of the publisher of the particular digital content item; and

possibly transferring applicable fees (e.g., gas in IRON) from the Buyer's wallet address to the wallet address of the node operator that processes the Resale message and executes the Resale contract.

In embodiments, the signed Resale message can include data fields corresponding to Ethereum transactions, including:
Nonce, which is the transaction sequence number for the sending user's address (e.g., the Buyer's wallet address);
Gas price, which is the price of gas the sending user is offering to pay;
Start gas, which is the maximum amount of gas allowed for the transaction;
To, which is the destination address of the message (either an account address or contract address);
Value, which is the amount of cryptocurrency (e.g., IRON) to transfer to the destination address, if any;
Data for the transaction, which can encode raw data or a contract function signature and parameters; and p1 v/r/s, which are components of the ECDSA signature of the sending user (e.g., the Buyer's signature).

Note that the data fields can be RLP-encoded in the order shown. Also note that the field names are not part of the encoded data fields.

In embodiments, the method(s) of the Resale contract for the particular digital content item as stored in the distributed ledger (block 555) can be invoked by sending a signed Resale message (e.g., Resale transaction or a Call to the Resale contract) to the address assigned to the Resale contract. These mechanisms are similar to the mechanisms for invoking smart contracts in the Ethereum protocol. In particular, the Resale contract can be previously compiled and stored on the distributed ledger at an assigned address. The Resale contract can be invoked by sending the signed Resale transaction to the address assigned to the Resale contract or by calling the address assigned to the Resale contract and passing one or more parameters and optionally, indicating one or more methods or subfunctions within the Resale contract. Examples of parameters may include, but are not limited or restricted to, contact information of the Buyer (name, address, city, state, zip), the Buyer's wallet address, contact information of the Seller (name, address, city, state, zip), and the Buyer's wallet address.

When the account balance of the Buyer's wallet address does not contain sufficient cryptocurrency (e.g., IRON) or other form of payment to purchase the ownership token for the particular digital media content item, the platform may provide a suggestion, e.g., via a pop-up screen, that the user convert other cryptocurrency or fiat into the cryptocurrency (e.g., IRON) of the platform 100.

Data can be stored and retrieved from the Resale contract via an Application Binary Interface (ABI). The ABI will also determine implementation details such as how methods of functions are called and in which binary format information should be passed from one program component to the next. The ABI can be used to ensure that specific desired contract function can be invoked while ensuring that the function will return data in the format expected.

In embodiments, the Resale contract can possibly include the ability to transfer cryptocurrency (e.g., IRON) to investors, management, etc. (optionally along with selling locks to ensure the cryptocurrency is not sold within a predetermined amount of time); transfer cryptocurrency (e.g., IRON) to buyers and sellers; provide refunds by transferring cryptocurrency (e.g., IRON) to the wallet address of a buyer or other party requesting the refund; and burn cryptocurrency by sending cryptocurrency to an invalid address.

In block 560, each ledger node 160 that receives the signed Resale message adds the signed Resale message (Resale transaction or call to the Resale contract) to its pool (or queue) of pending messages.

In block 570, a miner node (which belongs to the one or more ledger nodes 160) selects a number of pending messages from the pool (which can include the Resale message) and validates the selected messages. The validation of the Resale message can involve or trigger the execution of the Resale contract for the particular digital media content item as stored in the distributed ledger. Such validation can also include additional operations, such as:

verifying that the balance of available cryptocurrency or other form of payment of the Buyer's wallet address (e.g., sending user's address) is equal to or exceeds the value of cryptocurrency or other form of payment transferred from the Buyer's wallet address by the Resale message;

verifying that the signature of the Buyer corresponds to the Buyer's wallet address (which is derived from the Buyer's public key);

verifying that the signature of the participant seller corresponds to the participant seller's wallet address (which is derived from the participant seller's public key); and

verifying other necessary conditions or rules.

In this embodiment, the verification of the signature of the participant seller can provide for effective electronic authorization by the Seller of the transfer of the digital token to the Buyer. The verification of the signature of the Buyer can provide for effective electronic authorization by the Buyer of the transfer of cryptocurrency or other form of payment for the ownership token from the Buyer to the various participants. The execution of the Resale contract can transfer such digital token to the Buyer, transfer the purchase price for the ownership token to various participants and possibly perform other actions as described herein.

In block 580, the mining node forms (or mine) a new block, which includes data representing the signed Resale message as well as data representing the ownership token held by the Buyer user as a result of the execution of the Resale contract.

In block 590, the mining node propagates the new block to the ledger nodes 160 of the network for consensus. In order to achieve consensus, each ledger node 160 receiving the broadcasted new block can execute the transactions (including the execution of the Resale contract) in the order specified by the new block, and record the resulting changes. Each ledger node 160 can verify that the new block as valid and if so, add the data for the new block to its copy of the distributed ledger (block 593). The validation of the new block can involve validating each message that is part of the block in a manner similar to the validation of the Resale message as described above.

With the Resale message (and the execution results of the corresponding Resale contract) stored as part of the state of the distributed ledger (block 593), the online wallet system 120 can remove the copy of the ownership token for the particular digital media content item stored as part of the Seller's hold account (block 296-2). In other words, the copy of the ownership token is removed from storage by the online wallet system 120 in association with the Seller's wallet address. In effect, this forbids or denies the Seller rightful access to delivery and subsequent use of the particular digital media content item from the CDN nodes 130 (FIG. 6). Furthermore, the online wallet system 120 can store a copy of the ownership token for the particular digital media content item as part of the Buyer's wallet account (block 295-1). In other words, the copy of the ownership token can be stored by the online wallet system 120 and associated with the Buyer's wallet address.

Furthermore, the copy of the ownership token stored by the online wallet system 120 and associated with the Buyer's wallet address (block 295-1) can be checked to give the Buyer rightful access to delivery of the particular digital media content item from the CDN nodes 130. Specifically, the ownership token can be required to request delivery (or perfect delivery) of the particular digital media content item from the CDN nodes 130 and unlock the DRM security features of the particular digital media content item as delivered from the CDN nodes 130 (FIG. 6).

FIG. 6 illustrates another embodiment of a process where the ownership token for a specific digital media content item that is held by a user's address is checked to permit access to the specific digital media content item.

In block 610, the online transaction system 110 and the user device 140 can employ functionality (e.g., an authentication service) for user login to authenticate a user and allow access to the online transaction system 110.

In block 620, the online transaction system 110 and the user device 140 can employ functionality that allows the authenticated user to browse a database of digital media content items (e.g., online games).

In block 630, the online transaction system 110 and the user device 140 can employ functionality that allows the authenticated user to request access to (e.g., play) a specific digital media content item, which triggers a request to the functionality of block 635 of the online wallet system 120.

In embodiments, the functionality of blocks 610, 620 and 630 can be embodied by a client-server model where the online transaction system 110 acts as a server and the user device 140 acts as a client whereby the server online transaction system provides the necessary services as requested by the client user device.

In block 635, the online wallet system 120 checks its storage of data representing copy(ies) of one or more ownership tokens (or references to such token(s)) that are held by the user's wallet address (block 295) as well as its storage of data representing copy(ies) of one or more ownership tokens (or references to such token(s)) that are offered for sale and held by the user's hold account (block 296). The data of block 295 is derived from the ownership tokens that are held by the user's wallet address, which are dictated by one or more corresponding Purchase messages (with execution of the Purchase contract), and/or or by a corresponding Resale messages (with execution of the Resale contract), and represented by the state of the distributed ledger as stored by the blocks of the distributed ledger (block 293 or 593). The data of block 296 is derived from the ownership tokens that are held by the user's wallet address and offered or otherwise designated for sale by the user. If block 295 or block 296 of the online wallet system 120 stores data representing a copy of an ownership token for the specific digital media content item (or a reference to such token(s)) that is held by the user's wallet address, the matching ownership token is returned to the online transaction system 110. Otherwise (when blocks 295 and 296 of the online wallet system 120 do not store data representing a copy of an ownership token for the specific digital media content item (or a reference to such token(s)), the online wallet system 120 returns an empty or null value to the online transaction system 110.

In block 640, the online transaction system 110 processes the data returned online wallet system 120 to determine if such data is a valid ownership token copy. If so, the operations continue to block 650. If not, the operations continue to block 660.

In block 650, the online transaction system 110 authorizes a run-time engine (wrapper) executing on the client device 140 to download and play (or otherwise access) the specific digital content item from the CDN nodes 130. Specifically, the ownership token can be required to request delivery (or perfect delivery) of the specific digital media content item from the CDN nodes 130 and unlock the DRM security features of the specific digital media content item as delivered from the CDN nodes 130.

In block 660, the online transaction system 110 denies access to the specific digital media content item as stored in the CDN nodes 130 and can cooperate with the user device 140 to report to user that access to the specific digital content item is not authorized.

In alternate embodiments, data representing a Seller's ownership token that has been offered or otherwise designated for resale, and possibly data representing the associated Seller's commission, can be stored on behalf of the Seller as part of a service-controlled “hold” account, which replaces the user hold account (block 296-2) in FIG. 5. The service-controlled “hold” account can be maintained by the online wallet system 120 or possibly in some other data store maintained by the service provider. Note that any message that transfers an ownership token held in the service-controlled hold account to another user via a Resale contract requires a signature based on the private key of a participant seller (such as the service provider entity or administrator or publisher of the particular content item). The private key of the participant seller can be maintained by the online wallet system 120 or possibly in some other data store maintained by the service provider such that it is available when needed. The service-controlled “hold” account is a form of escrow account where ownership token is held by the participant seller for the benefit of the appropriate Seller. The service-controlled “hold” account is designed to minimize any delay in transferring the ownership token held by the Seller to another user via resale, where such delay might occur because the Seller is unavailable and thus cannot provide input that is required to generate an appropriate signature derived from the Seller's private key.

Note that multiple users might possibly have offered for resale an ownership token for the same digital media content item. In this case, data representing such ownership tokens and possibly the data representing the corresponding Sellers' commissions can be stored in the service-controlled “hold” account and processed (which can possibly involve ranking the Sellers and corresponding ownership tokens based on the lowest Seller's commission) to select one of the available ownership tokens to be resold to a Buyer of the corresponding digital media content item. Other mechanisms, such as barter or auction or exchange services, can also be used to match the Buyer (via the Buyer's wallet address) to the Seller (via the Seller's wallet address).

In this embodiment, the purchase action of the Buyer can trigger the generation of a Resale message specific to the particular digital media content item (e.g., a Resale transaction or call to a Resale contract specific to the particular digital media content item). The Resale message can include one or more of the following data: the Buyer's wallet address, a signature derived from the private key of the Buyer, a wallet address of the participant seller, and a signature derived from the private key of the participant seller. The Buyer's wallet address identifies the intended recipient of the ownership token for the particular digital media content item. The signature derived from the private key of the Buyer can be verified against the Buyer's wallet address (public key) to verify that the Buyer has authorized the Resale message and its actions, particularly the transfer of cryptocurrency or other form of payment from the Buyer. The signature derived from the private key of the participant seller can be verified against the participant seller's wallet address (public key) to verify that the participant seller has authorized the Resale message and its actions, particularly the transfer of such ownership token from the Seller (via the service-controlled hold account) to the Buyer (via the Buyer's wallet address). The Resale message can also specify other data items for input to the Resale contract, such as the Seller's commission, the purchase price for the Seller's ownership token, and the percentage of the purchase price to transfer to various participants (such as the service provider and publisher of the particular digital media content item). The Resale message is transmitted and propagated across the ledger nodes 160. The Resale message invokes the terms of the Resale contract specific to the particular digital media content item, which when executed transfers the ownership token for the particular digital media content item from the Seller (via the service-controlled hold account) to the Buyer (via the Buyer's wallet address). When the ownership token is held by the Buyer by association with the Buyer's wallet address, the ownership token grants only the Buyer (through the Buyer's wallet address) permission to access the associated digital media content item unless such ownership token is transferred from the Buyer to another user by the invocation of a follow-on Resale contract.

Note that when checking that the ownership token for a specific digital media content item is held by a user's address for permitting access to the specific digital media content item as described above with respect to FIG. 6, the operations of block 635 are adapted such that the online wallet system 120 checks its storage of data representing copy(ies) of one or more ownership tokens (or references to such token(s)) that are held by the user's wallet address (block 295) as well as its storage of data representing copy(ies) of one or more ownership tokens (or references to such token(s)) that are offered for sale and held by the service-controller hold account (block 296).

In embodiments, the ownership tokens as described herein can include the following data fields:
a tokenID field (which, for example, can be realized by a variable type of 256 bits in length); the tokenID field is an identifier or index that identifies the ownership token;
a tokenStoreItemId field (which, for example, can be realized by a variable type of 256 bits in length); the tokenStoreItemId field represents a link to a specific digital content item that can be accessed from the CDN nodes 130;
an expirationDate field (which, for example, can be realized by a variable type of 256 bits in length); the expirationDate field can represent a date that the ownership token expires, if any;
a Demo flag (which, for example, can be realized by a Boolean variable type); the Demo flag can be used to indicate a free digital content item, and the expirationDate field can be set to a timeout when the free access expires (such as 30 days); in this case, the contracts stored on the digital ledger can expire this digital token automatically based on the expirationDate field;
an Enabled flag and an Exists flag (which, for example, can be realized by a Boolean variable type); the Enabled and Exists flags can be used by the contracts stored on the digital ledger to disable and remove access granted by the digital token (for example, when a publisher loses rights to sell the associated digital content item, or the user is getting a refund); and
one or more other flags (which, for example, can be realized by a Boolean variable type) that are used by the contracts stored on the digital ledger for different purposes, such as providing access to extra content, special content, etc.

Note that other embodiments of the digital token can include additional or other data field as deemed necessary or suitable by the system design.

In embodiments, the ownership tokens as described herein can be fungible in nature. In this case, the number of ownership tokens created for the Purchase and Resale contracts are interchangeable with one another. The ownership of such fungible-type ownership tokens can be managed by mapping balances of the ownership tokens to respective users' wallet addresses. For each user wallet address, this mapping associates a balance of ownership tokens to the user wallet address. An ER20 token is an example of a fungible-type ownership token.

The fungible-type ownership token can be created by a function or other programming construct that is used to set or increase the total number of available ownership tokens. For example, in an ER20 token, a contact construction can set an initial value of the total supply of available tokens, totalSupply. Or a mint( ) function can be used to add a desired amount of tokens to the total supply of available tokens, totalSupply.

The fungible-type ownership token can be transferred between users by a function or other programming construct that specifies as inputs an amount of ownership tokens, a source wallet address to transfer the amount of ownership tokens from, a destination wallet address to transfer the amount of ownership tokens to. The execution of the function or programming construct can transfer the specified amount of ownership tokens from the source wallet address to the destination wallet address, which deducts the specified amount of ownership tokens from the balance of ownership tokens associated with the source wallet address and adds the specified amount of ownership tokens to the balance of ownership tokens associated with the destination wallet address. For example, in an ER20 token, a transferFrom( )function can specify as inputs an amount of tokens, a source wallet address to transfer the amount of tokens from, a destination wallet address to transfer the amount of tokens to. The execution of the transferFrom( )function can transfer the specified amount of tokens from the source wallet address to the destination wallet address, which deducts the specified amount of tokens from the balance of tokens associated with the source wallet address and adds the specified amount of tokens to the balance of tokens associated with the destination wallet address.

The fungible-type ownership token can be eliminated (or destroyed or burned) by a function or other programming construct that specifies as input an amount of ownership tokens to eliminate or destroy. The execution of the function or programming construct can eliminate the specified amount of ownership tokens associated with a designated wallet address (such as the wallet address of the message sender). For example, in an ER20 token, a burn( ) function can specify as input an amount of tokens to eliminate or destroy. The execution of the burn( ) function eliminates the specified amount of tokens from the wallet address of the message sender, which deducts the specified amount of tokens from the balance of tokens associated with the wallet address of the message sender, and deducts the specified amount of tokens from the total supply of available tokens, totalSupply.

It is also contemplated that a fungible-type ownership token can be transferred between users (seller to buyer) by a function or other programming construct that eliminates or destroys an ownership token belonging to seller, which deducts the ownership token from the balance of ownership tokens associated with the wallet address of the seller, and deducts the one eliminated ownership token from the total supply of available tokens, totalSupply, and then creates an ownership token and assigns it to the buyer, which adds the one ownership token to the balance of tokens associated with the wallet address of the buyer, and adds the one ownership token to total supply of available ownership tokens, totalSupply.

In other embodiments, the ownership tokens as described herein can be non-fungible in nature. In this case, the number of ownership tokens created for the Purchase and Resale contracts are not interchangeable with one another. The ownership of such non-fungible-type ownership tokens can be managed by mapping arrays of token indexes or ids to respective users' wallet addresses. For each user wallet address, this mapping associates an array of token indexes or ids to the user wallet address. An ER721 token is an example of a non-fungible token.

The non-fungible-type ownership token can be created by a function or other programming construct that specifies as inputs a unique token id for a new ownership token and a wallet address that will own the new ownership token. The execution of the function or programming construct can create the new ownership token with the specified unique token id and assigns the new ownership token to the specified wallet address that will own the ownership token. For example, in a ER721 token, a mint( ) function specifies as inputs a unique token id for a new token and a wallet address that will own the new token. The execution of the mint ( )function creates the new token with the specified unique token id and assigns the new token to the specified wallet address that will own the token, which updates the mapping such that the array of token indexes or ids that are associated with the specified wallet address includes the specified unique token id.

The non-fungible-type ownership tokens can be transferred between users by a function or other programming construct that specifies as inputs a token id for an ownership token to transfer, a source wallet address to transfer the ownership token from, and a destination wallet address to transfer the ownership token to. The execution of the function or programming construct can transfer the specified ownership token (by the token id) from the source wallet address to the destination wallet address, which removes the specified token id from the array of token ids associated with the source wallet address and adds the specified token id from the array of token ids associated with the destination wallet address. For example, in an ER721 token, a transferFrom( ) function can specify as inputs a token id for a token to transfer, a source wallet address to transfer the token from, a destination wallet address to transfer the token to. The execution of the transferFrom( ) function transfers the specified token (by the token id) from the source wallet address to the destination wallet address, which removes the specified token id from the array of token ids associated with the source wallet address and adds the specified token id from the array of token ids associated with the destination wallet address. Other safe forms of the transferFrom( ) function can also be used.

The non-fungible-type ownership token can be eliminated (or destroyed or burned) by a function or other programming construct that specifies as inputs a token id for an ownership token to eliminate or destroy, and a source wallet address for the ownership token. The execution of the function or programming construct can eliminate the specified ownership token (by the token id) from the source wallet address, which removes the specified token id from the array of token ids associated with the source wallet address. For example, in an ER721 token, a removeTokenFrom( ) function can specify as inputs a token id for a token to eliminate, a source wallet address for the token. The execution of the removeTokenFrom( ) function can eliminate the specified token (by the token id) from the source wallet address, which removes the specified token id from the array of token ids associated with the source wallet address.

It is also contemplated that a non-fungible-type ownership token can be transferred between users (seller to buyer) by a function or other programming construct that eliminates or destroys an ownership token belonging to seller, which can eliminate the specified token (by the token id) from the seller's wallet address, which removes the specified token id from the array of token ids associated with the seller's wallet address, and deducts the one eliminated ownership token from the supply of available tokens, and then creates an ownership token and assigns it to the buyer, which adds the one ownership token to the balance of tokens associated with the wallet address of the buyer, which adds the new token id to the array of token ids associated with the buyer's wallet address, and adds the new token id to the supply of available tokens.

FIG. 7A shows an exemplary network of ledger network codes 160 and the transmission of a signed Purchase message (or a signed Resale message) to a ledger node 160 for propagation to the other ledger nodes 160 of the network, validation and execution of the correspond contract code, and mining as part of a new block of the distributed ledger maintained by the network of ledger nodes 160. In embodiments, the blocks of the distributed ledger can be linked to one another through information stored in the respective block headers as shown in FIG. 7B. In this case, each block is a collection of relevant pieces of information (known as the block header with information (typically organized as Merkle Trees) corresponding to the transactions and resulting state of the block. The root of these Merkle Trees (e.g., Transaction Root, State Root, Result Root) are stored in the block header. The blocks are linked together in a sequential manner by storing the hash of the previous block in the block header as shown.

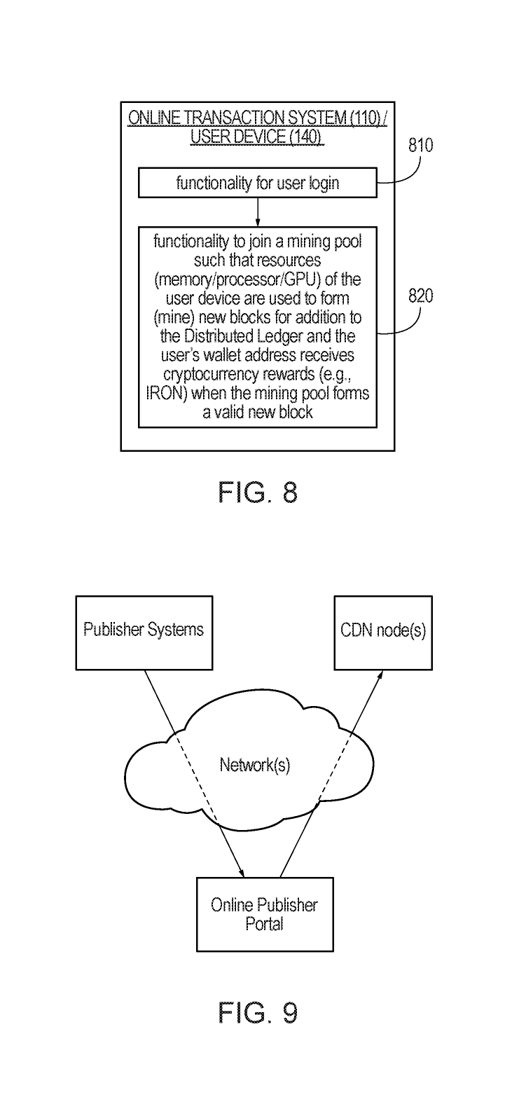

FIG. 8 shows additional features of the service 100 that can be provided to allow a user device to contribute computing resources to the work required to form (mine) new blocks of the distributed ledger.

In block 810, the online transaction system 110 and the user device 140 can employ functionality (e.g., an authentication service) for user login to authenticate a user and allow access to the online transaction system 110.

In block 820, the online transaction system 110 and the user device 140 can employ functionality that allows the user to join a mining pool such that resources (memory/processor/GPU) of the user device contribute to the work required to form (mine) new blocks of the distributed ledger. In return for such computational work, the user's wallet address can receive cryptocurrency rewards (e.g., IRON) when the mining pool forms a valid new block. Such cryptocurrency rewards can accumulate and contribute the user's balance of cryptocurrency (e.g., IRON), which can be used to purchase digital media content items by the user as described herein.

In embodiments, the functionality of blocks 810 and 820 can be embodied by a client-server model where the online transaction system 110 acts as a server and the user device 140 acts as a client whereby the server online transaction system provides the necessary services as requested by the client user device.

In embodiments, the functionality of block 820 can provide the user with the ability to select a percentage of their hardware that is to be dedicated to mining (e.g., 20% of their hardware to be utilized for mining while 80% of their hardware is reserved for other tasks, including, for example, gaming). In one example, a GUI may be provided that enables the user to select a particular percentage. The user may also be able to select percentages of individual hardware components (e.g., a first percentage of a first CPU, a second percentage of a first GPU, etc.).

Additionally or alternatively, the functionality of block 820 may utilize default configurations when the user selects percentages of their hardware to use for mining (e.g., predetermined default overclocking configurations). In other embodiments, the user may also be able to alter default configuration settings. In addition, in some embodiments, the user may be able to set a timer for set percentages of their hardware to automatically begin and stop mining (e.g., to enable automatic mining while the user is sleeping, e.g., from 10 pm to 8 am).

FIG. 9 shows additional features of the service 100 that can be provided to allow Publishers and developers have access to an online publisher portal where they can post information about their digital media content items (e.g., online video games) and their companies. This portal can be configured to allow Publishers and developers upload and manage all content related to their digital media content items (e.g., online video games) through computer system systems (labeled “Publisher Systems). The portal can be configured to store copies of the digital media content items in the nodes 120 of the CDN network for access by user. The service 100 can provide seamless protection of such content using the run-time engine (or game wrapper) that is executed by the user devices to access the content. Specifically, the run-time engine can be configured to prevent user access to the content without the proper ownership token stored on the blockchain and associated to the user's account. Furthermore, the content items can be independently encrypted using a unique encryption key to ensure all content items are unique even in how they are encrypted.

### Other Features

In some embodiments, the platform may award cryptocurrency amounts merely for access and use of a particular digital media content item (e.g., for playing an online video game) on the platform. For example, merely playing any game a predetermined amount of time (e.g., minutes, hours, days) or a predetermined number of times (e.g., 10 times, 30 times, 30 different days), etc., may result in the user being awarded a share of cryptocurrency. Alternatively, a small portion of cryptocurrency may be awarded at each transaction (e.g., buy, sell, launching of a game) so that a user may accumulate cryptocurrency to make additional purchases after a series of transactions or time spent on the platform.

In other embodiments, other mechanisms can be used such that users can receive discounts on purchases or earn cryptocurrency. For example, a user can receive cryptocurrency in return for inviting other users to the platform. Specifically, for each referred user who purchases a content item (e.g., game) on the platform, the referring user can receive some amount of cryptocurrency (e.g., IRON) and could also receive additional cryptocurrency based on a percentage of the mining rewards to the new user.

In another example, users can be rewarded for behaviors that have tangible benefits to the platform. There are three possible reward components: individual rewards, community rewards, and social rewards. The reward components can be implemented as smart contracts that are stored on the distributed ledger. The following are examples of the reward components:

As individual rewards, when a user purchases his or her 1st game, the smart contract will release a small amount of cryptocurrency to the gamer. On the user's 10th purchase, he or she will be rewarded again with more cryptocurrency.

As community rewards, when the total number of active users on the platform reach certain numbers, all users who own at least one game will be rewarded with cryptocurrency based on their total purchases. When the platform has 25,000 active users, cryptocurrency can be released to all users in a relative amount to their purchases. Or, when 25,000 games have been resold, cryptocurrency can be released to any user that participated in a resale.

As social rewards, when a user refers a friend to the platform and the friend purchases a game, the referring user can receive cryptocurrency.

Furthermore, the online wallet system 120 (or parts thereof) can be provided and managed by a wallet provider that is separate and distinct from the service provider that provides and manages the online transaction system 110 and possibly other parts of the system.

Moreover, the cryptocurrency of the platform (e.g., IRON) can be an ERC-20 token, which is supported universally by Ethereum and Ethereum forks. The use of an ERC-20 token ensures that the transactions will settle quickly (usually in under 30 seconds) and benefit from the robust development of the Ethereum network.

In other embodiments, such as in a blockchain network based on the Bitcoin protocol, the assignment of the ownership token to the Buyer as carried out by the Purchase contract (or Resale contract) as described above can be encoded in one or more transactions that are validated and stored as part of the blockchain.

In one example, the assignment of the ownership token to the Buyer can be encoded by a Purchase transaction with a transaction input referencing UTXO of the Buyer with a signature based on the Buyer's private key and one or more transaction outputs that specify an amount of cryptocurrency (e.g., IRON) and corresponding locking script that specifies the address (public key) for the party to be paid. For example, a first transaction output can specify an amount of cryptocurrency (e.g., IRON) for 5% of the token price and a corresponding locking script that specifies an address (public key) for the service provider, while a second transaction output can specify an amount of cryptocurrency (e.g., IRON) for 95% of the token price and a corresponding locking script that specifies an address (public key) for the publisher. Such transaction outputs can be claimed or spent by the particular party by a spending transaction with a transaction input that refers to the corresponding transaction output (UTXO) and includes an unlocking script with a digital signature that matches the address (public key) for the party as specified in the locking script of the UTXO. Data representing the ownership token itself and the ownership of the token by the Buyer can be included as part of the Purchase transaction and generated when the Purchase transaction is constructed. The construction of the Purchase transaction can possibly be performed by the online wallet system 120, the online transaction system 110 or some other system. In this case, when the Purchase transaction is validated and then stored in the blockchain, the Purchase transaction includes the data representing the ownership token itself and the ownership of the token held by the Buyer as part of the Purchase transaction. Alternatively, data representing the ownership token itself and the ownership of the token held by the Buyer can be generated by the online wallet system 120, the online transaction system 110 or some other system and input to the Purchase transaction during execution of a locking script of the Purchase transaction as part of script validation. In this case, when the Purchase transaction is validated and then stored in the blockchain, the Purchase transaction includes the data representing the ownership token itself and the ownership of the token held by the Buyer as part of the Purchase transaction.

In another example, the transfer of the ownership token from the Seller to the Buyer can be encoded by a Resale transaction with a transaction input referencing UTXO of the Buyer with a signature based on the Buyer's private key and one or more transaction outputs that specify an amount of cryptocurrency (e.g., IRON) and corresponding locking script that specifies the address (public key) for the party to be paid. For example, a first transaction output can specify an amount of cryptocurrency (e.g., IRON) for 5% of the token price and a corresponding locking script that specifies an address (public key) for the service provider, while a second transaction output can specify an amount of cryptocurrency (e.g., IRON) for 20% of the token price and a corresponding locking script that specifies an address (public key) for the Seller, and a third transaction output can specify an amount of cryptocurrency (e.g., IRON) for 75% of the token price and a corresponding locking script that specifies an address (public key) for the publisher. Such transaction outputs can be claimed or spent by the particular party by a spending transaction with a transaction input that refers to the corresponding transaction output (UTXO) and includes an unlocking script with a digital signature that matches the address (public key) for the party as specified in the locking script of the UTXO. Data representing the ownership token itself and the transfer of ownership of the token from the Seller to the Buyer can be included as part of the Resale transaction and generated when the Resale transaction is constructed. The construction of the Resale transaction can possibly be performed by the online wallet system 120, the online transaction system 110 or some other system. In this case, when the Resale transaction is validated and then stored in the blockchain, the Resale transaction includes the data representing the ownership token itself and the transfer of ownership of the token from the Seller to the Buyer as part of the Resale transaction. Alternatively, data representing the ownership token itself and the transfer of ownership of the token from the Seller to the Buyer can be generated by the online wallet system 120, the online transaction system 110 or some other system and input to the Resale transaction during execution of a locking script of the transaction as part of script validation. In this case, when the Resale transaction is validated and then stored in the blockchain, the Resale transaction includes the data representing the ownership token itself and the transfer of ownership of the token from the Seller to the Buyer as part of the Resale transaction.

Certain embodiments as described herein can include logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

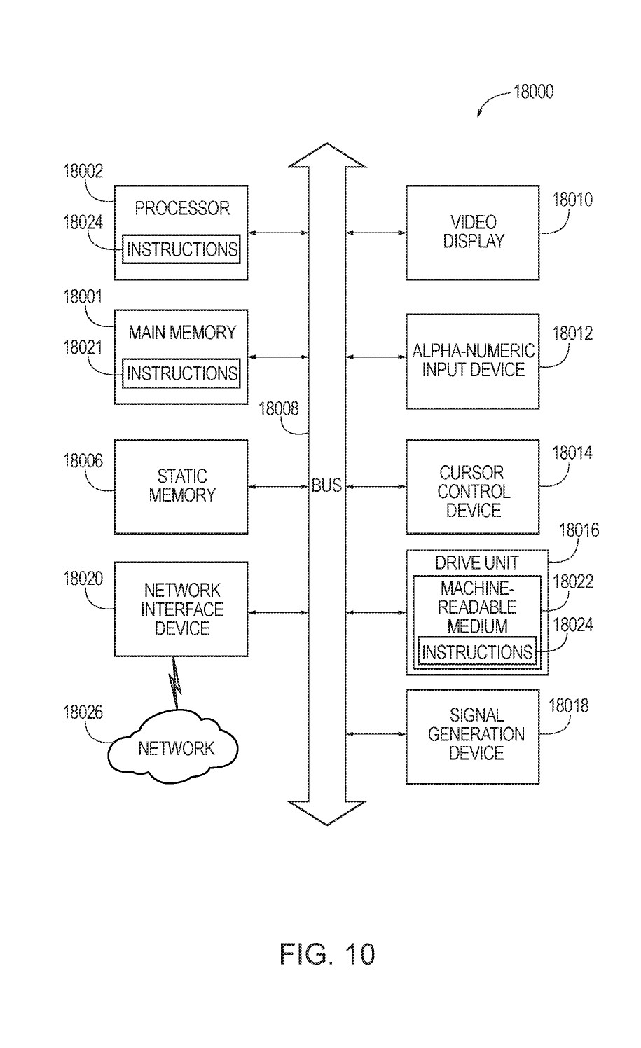

FIG. 10 shows a diagrammatic representation of a machine in the example form of a computer system 18000 within which a set of instructions for causing the machine to perform any one or more of the methods, processes, operations, or methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Personal Digital Assistant (PDA), a cellular telephone or smartphone, a Web appliance, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments may also be practiced in distributed system environments where local and remote computer systems which that are linked (e.g., either by hardwired, wireless, or a combination of hardwired and wireless connections) through a network, both perform tasks. In a distributed system environment, program modules may be located in both local and remote memory-storage devices (see below).

The example computer system 18000 includes a processor 18002 (e.g., a Central Processing Unit (CPU), a Graphics Processing Unit (GPU) or both), a main memory 18001 and a static memory 18006, which communicate with each other via a bus 18008. The computer system 18000 may further include a video display unit 18010 (e.g., a Liquid Crystal Display (LCD) or a Cathode Ray Tube (CRT)). The computer system 18000 also includes an alphanumeric input device 18012 (e.g., a keyboard), a User Interface (UI) cursor controller 18014 (e.g., a mouse), a disk drive unit 18016, a signal generation device 18018 (e.g., a speaker) and a network interface device 18020 (e.g., a transmitter).

The disk drive unit 18016 includes a machine-readable medium 18022 on which is stored one or more sets of instructions 18024 and data structures (e.g., software) embodying or used by one or more of the methodologies or functions illustrated herein. The software may also reside, completely or at least partially, within the main memory 18001 and/or within the processor 18002 during execution thereof by the computer system 18000, the main memory 18001 and the processor 18002 also constituting machine-readable media.

The instructions 18024 may further be transmitted or received over a network 18026 via the network interface device 18020 using any one of a number of well-known transfer protocols (e.g., HTTP, Session Initiation Protocol (SIP)).

The term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies illustrated herein. The term “machine-readable medium” shall accordingly be taken to include, but not be limited to, solid-state memories, and optical and magnetic medium.

Method embodiments illustrated herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, Random Access Memories (RAMs), Read Only Memories (ROMs), and the like.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

There have been described and illustrated herein several embodiments of methods and system s for distributing digital media content items, such as on-line games, using a distributed ledger. While particular embodiments of the invention have been described, it is not intended that the invention be limited thereto, as it is intended that the invention be as broad in scope as the art will allow and that the specification be read likewise. Thus, while particular message and transaction constructs have been disclosed, it will be appreciated that other message and transaction constructs can be used as well. Furthermore, while particular distributed ledger technologies (such as Ethereum and Bitcoin) can be used, it will be understood that other distributed ledger technologies can be similarly used. It will therefore be appreciated by those skilled in the art that yet other modifications could be made to the provided invention without deviating from its spirit and scope as claimed.

What is claimed is:

1. A computer-implemented method comprising:
storing first data in a distributed ledger maintained by a plurality of nodes, wherein the first data represents a purchase contract that assigns a digital token associated with a particular digital media content item to a first user in return for payment by the first user; and
storing second data in the distributed ledger maintained by the plurality of nodes, wherein the second data represents a resale contract that transfers the digital token associated with the particular digital media content item and stored as part of the first data to a second user in return for payment by the second user.

2. A computer-implemented method according to claim 1, wherein:
the payment by the first user is in the form of cryptocurrency, fiat currency, store credit, or other form of value; and
the payment by the second user is in the form of cryptocurrency, fiat currency, store credit, or other form of value.

3. The computer-implemented method of claim 1, wherein:
the digital token associated with the particular digital media content item as part of the first data grants only the first user permission to access the particular digital media content item unless such digital token is transferred from the first user to another user by data representing a resale contract that is stored in the digital ledger; and
the digital token associated with the particular digital media content item as part of the second data grants only the second user permission to the particular digital media content item unless such digital token is transferred from the second user to another user by data representing a resale contract that is stored in the digital ledger.

4. The computer-implemented method of claim 1, wherein:
the first data is added to the distributed ledger maintained by a plurality of nodes by consensus of the plurality of nodes; and
the second data is added to the distributed ledger maintained by a plurality of nodes by consensus of the plurality of nodes.

5. The computer-implemented method of claim 1, wherein:
the distributed ledger comprises a blockchain.

6. The computer-implemented method of claim 5, wherein:
the first data is validated by the plurality of nodes for addition to pools maintained by the plurality of nodes;
the first data is selected from a pool for mining and added to a new block that is linked to an earlier block as part of the blockchain;
the second data is validated by the plurality of nodes for addition to the pools; and
the second data is selected from a pool for mining and added to another new block that is linked to an earlier block as part of the blockchain.

7. The computer-implemented method of claim 1, wherein:
terms of the purchase contract are specific to the particular media content item and invoked by at least one purchase message that is propagated by the plurality of nodes and stored in the distributed ledger, and the terms of the purchase contract are represented by a first contract transaction stored in the distributed ledger with an assigned first address; and
terms of the resale contract are specific to the particular media content item and invoked by at least one resale messages that is propagated by the plurality of nodes and stored in the distributed ledger, and the terms of the resale contract are represented by a second contract transaction stored in the distributed ledger with an assigned second address.

8. The computer-implemented method of claim 7, wherein:
the purchase contract is invoked by a purchase message that is validated to authorize creation of a digital token associated with the particular digital media content item and assignment of such digital token to the first user; and
the validation of the purchase message optionally includes verifying that a digital signature including in purchase message corresponds to a wallet address of a participating seller.

9. The computer-implemented method of claim 1, further comprising:
selectively permitting a user to access a specific digital media content item by checking that an address of the user holds a digital token corresponding to the specific digital media content item as represented by current state of the distributed ledger.

10. The computer-implemented method of claim 9, further comprising:
maintaining a user-specific wallet account storing information associated with a wallet address of the user, wherein such information includes data representing each digital token that is held by the user and corresponding to a given digital media content item as represented by current state of the distributed ledger; and
the address checking involves checking the user-specific wallet account to verify that the user-specific wallet account stores data representing a valid digital token that is held by the user for the specific digital media content item.

11. The computer-implemented method of claim 10, wherein:
transfer of a digital token that is held by the user and that has been offered or otherwise designated for resale by the user is authorized by a valid digital signature derived from a private key of the user.

12. The computer-implemented method of claim 11, wherein:
the resale contract is invoked by a resale message that includes a digital signature derived from a private key of the first user in order to authorize transfer of the digital token associated with the particular digital media content item from the first user;
the resale message is validated by verifying that the digital signature of the resale message corresponds to a wallet address of the first user;
the execution results of the resale contract are stored in the distributed ledger; and
in response to storing the execution results of the resale contract in the distributed ledger, removing the digital token associated with the particular digital media content item from the user-specific wallet account of the first user.

13. The computer-implemented method of claim 10, further comprising:
maintaining a user-specific hold account for the user that stores data representing at least one digital token that is held by the user and that has been offered or otherwise designated for resale by the user; and
the address checking further involves checking the user-specific hold account to verify that the user-specific hold account stores data representing a valid digital token that is held by the user for the specific digital media content item.

14. The computer-implemented method of claim 13, wherein:
transfer of a digital token that is held by the user and that has been offered or otherwise designated for resale by the user is authorized by a valid digital signature derived from a private key of a participating seller.

15. The computer-implemented method of claim 14, wherein:
the resale contract is invoked by a resale message that includes a digital signature derived from a private key of the participating seller in order to authorize transfer of the digital token associated with the particular digital media content item from the first user;
the resale message is validated by verifying that the digital signature of the resale message corresponds to a wallet address of the participant seller;
the execution results of the resale contract are stored in the distributed ledger; and
in response to storing the execution results of the resale contract in the distributed ledger, removing the digital token associated with the particular digital media content item from the user-specific hold account of the first user.

16. The computer-implemented method of claim 10, further comprising:
maintaining a service-controlled hold account storing data representing digital tokens that are held by users and that have been offered or otherwise designated for resale by the users; and
the address checking further involves checking the service-controlled hold account to verify that the service-controlled hold account stores data representing a valid digital token that is held by the user for the specific digital media content item.

17. The computer-implemented method of claim 16, wherein:
transfer of a digital token that is held by the user and that has been offered or otherwise designated for resale by the user is authorized by a valid digital signature derived from a private key of a participating seller.

18. The computer-implemented method of claim 14, wherein:
the resale contract is invoked by a resale message that includes a digital signature derived from a private key of the participating seller in order to authorize transfer of the digital token associated with the particular digital media content item from the first user;
the resale message is validated by verifying that the digital signature of the resale message corresponds to a wallet address of the participant seller;
the execution results of the resale contract are stored in the distributed ledger; and
in response to storing the execution results of the resale contract in the distributed ledger, removing the digital token associated with the particular digital media content item from the service-controlled hold account.

19. The computer-implemented method of claim 9, wherein:
the access to the specific digital media content item involves downloading data representing the specific digital media content item.

20. The computer-implemented method of claim 1, wherein:
the purchase contract of the first data transfers some portion of the payment made by the first user to an address for a service provider entity; and/or
the purchase contract of the first data transfers another portion of the payment made by the first user to an address for an entity that published the particular media content item; and/or
the resale contract of the second data transfers some portion of the payment made by the second user to an address for a service provider entity; and/or
the resale contract of the second data transfers another portion of the payment made by the second user to an address for an entity that published the particular media content item; and/or
the resale contract of the second data transfers another portion of the payment made by the second user to an address for the first user.

21. The computer-implemented method of claim 1, wherein:
the digital media content items are selected from the group consisting of online video games, other online games, audio files, video files, image files, electronic books, document files, other digital media, and combinations thereof.

22. The computer-implemented method of claim 1, wherein:
the digital token in fungible and thus is interchangeable with other digital tokens created for the Purchase and Resale contracts; or
the digital token in non-fungible and thus is not interchangeable with other digital tokens created for the Purchase and Resale contracts.

23. A system for distribution of media content items that uses a plurality of nodes that maintain copies of a distributed ledger, the system comprising:
an online transaction system that is operably coupled to user devices and the plurality of nodes by at least one communication network;
wherein the online transaction system cooperates with a first user device operated by the first user to store first data in the distributed ledger, wherein the first data represents a purchase contract that assigns a digital token associated with a particular digital media content item to the first user in return for payment by the first user; and
wherein the online transaction system cooperates with a second user device operated by the second user to store second data in the distributed ledger, wherein the second data represents a resale contract that transfers the digital token associated with the particular digital media content item and stored as part of the first data to the second user in return for payment by the second user.

24. A system of claim 23, wherein:
the payment by the first user is in the form of cryptocurrency, fiat currency, store credit, or other form of value; and
the payment by the second user is in the form of cryptocurrency, fiat currency, store credit, or other form of value.

25. The system of claim 23, wherein:
the digital token associated with the particular digital media content item as part of the first data grants only the first user permission to access the particular digital media content item unless such digital token is transferred from the first user to another user by data representing a resale contract that is stored in the digital ledger; and
the digital token associated with the particular digital media content item as part of the second data grants only the second user permission to access to the particular digital media content item unless such digital token is transferred from the second user to another user by data representing a resale contract that is stored in the digital ledger.

26. The system of claim 23, wherein:
the first data is added to the distributed ledger by consensus of the plurality of nodes; and
the second data is added to the distributed ledger by consensus of the plurality of nodes.

27. The system of claim 23, wherein:
the distributed ledger comprises a blockchain.

28. The system of claim 27, wherein:
the plurality of nodes validates the first data for addition to respective pools maintained by the plurality of nodes;
a mining node selects the first data from its pool and adds the first data to a new block that is linked to an earlier block as part of the blockchain;
the plurality of nodes validates the second data for addition to the respective pools; and
a mining node selects the second data from its pool and adds the second data to another new block that is linked to an earlier block as part of the blockchain.

29. The system of claim 23, wherein:
terms of the purchase contract are specific to the particular media content item and invoked by at least one purchase message that is propagated by the plurality of nodes and stored in the distributed ledger, and the terms of the purchase contract are represented by a first contract transaction stored in the distributed ledger with an assigned first address; and
terms of the resale contract are specific to the particular media content item and invoked by at least one resale messages that is propagated by the plurality of nodes and stored in the distributed ledger, and the terms of the resale contract are represented by a second contract transaction stored in the distributed ledger with an assigned second address.

30. The system of claim 23, wherein:
the online transaction system is further configured to selectively permit a user to access a specific digital media content item by checking that an address of the user holds a digital token corresponding to the specific digital media content item as represented by current state of the distributed ledger.
